(19) United States
(12) Patent Application Publication
(10) Pub. No.: US 2026/0019629 A1
(43) Pub. Date: Jan. 15, 2026

(54) METHOD, APPARATUS, AND MEDIUM FOR VIDEO PROCESSING

(71) Applicant: Bytedance Inc., Los Angeles, CA (US)

(72) Inventors: Mehdi SALEHIFAR, Los Angeles, CA (US); Yuwen HE, Los Angeles, CA (US); Kai ZHANG, Los Angeles, CA (US); Li ZHANG, Los Angeles, CA (US)

(21) Appl. No.: 19/338,967

(22) Filed: Sep. 24, 2025

Related U.S. Application Data
(63) Continuation of application No. PCT/US2024/021180, filed on Mar. 22, 2024.
(60) Provisional application No. 63/492,148, filed on Mar. 24, 2023.

(51) Int. Cl. H04N 19/577; H04N 19/513; H04N 19/52

(52) U.S. Cl. CPC H04N 19/577; H04N 19/52; H04N 19/521

(57) ABSTRACT

Embodiments of the present disclosure provide a solution for video processing. A method for video processing is proposed. The method comprises: determining at least one subblock for a current subblock of a current video block of the video from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock; and performing the conversion based on applying a bi-directional optical flow process on the combined subblock.

### CROSS REFERENCE

This application is a continuation of International Application No. PCT/US2024/021180, filed on Mar. 22, 2024, which claims the benefit of U.S. Provisional Application No. 63/492,148, filed on Mar. 24, 2023. The entire contents of these applications are hereby incorporated by reference in their entireties.

### FIELDS

Embodiments of the present disclosure relates generally to video processing techniques, and more particularly, to a bi-directional optical flow (BDOF) process.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, at least one subblock for a current subblock of the current video block from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock by combining the at least one subblock and the current subblock; and performing the conversion based on applying a bi-directional optical flow (BDOF) process on the combined subblock.

According to the method in accordance with the first aspect of the present disclosure, more than one subblocks with the same MV or similar MVs are combined, and the BDOF process is applied on the combined subblock, rather than being applied on each of the more than one subblocks individually. Compared with the conventional solution where the BDOF process is applied on subblocks individually, the proposed method can advantageously perform the BDOF process more efficiently. Thereby, the coding efficiency can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining at least one subblock for a current subblock of a current video block of the video from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock by combining the at least one subblock and the current subblock; and generating the bitstream based on applying a bi-directional optical flow (BDOF) process on the combined subblock.

In a fifth aspect, a method for storing a bitstream of a video is proposed. The method comprises: determining at least one subblock for a current subblock of a current video block of the video from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock by combining the at least one subblock and the current subblock; generating the bitstream based on applying a bi-directional optical flow (BDOF) process on the combined subblock; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates extended coding unit (CU) region used in BDOF;

FIG. 5 illustrates decoding side motion vector refinement;

FIG. 6 illustrates diamond regions in the search area;

FIG. 7 illustrates weights generated with an example Gaussian distribution;

FIG. 8 illustrates weights generated with a further example Gaussian distribution;

FIG. 9 illustrates weights generated with a still further example Gaussian distribution;

FIG. 10 illustrates weights generated with a still further example Gaussian distribution;

FIG. 11 illustrates different filter shapes applied on the data;

FIG. 12 illustrates a flowchart of a method for video processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

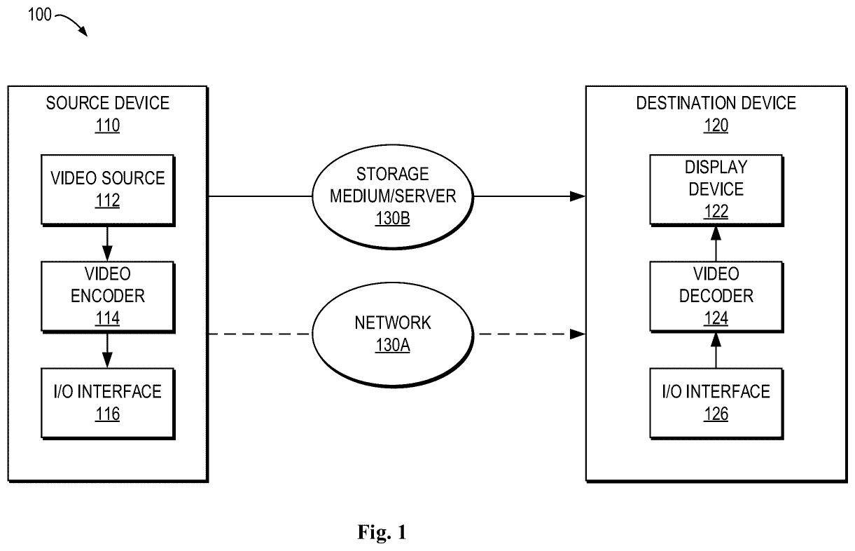

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

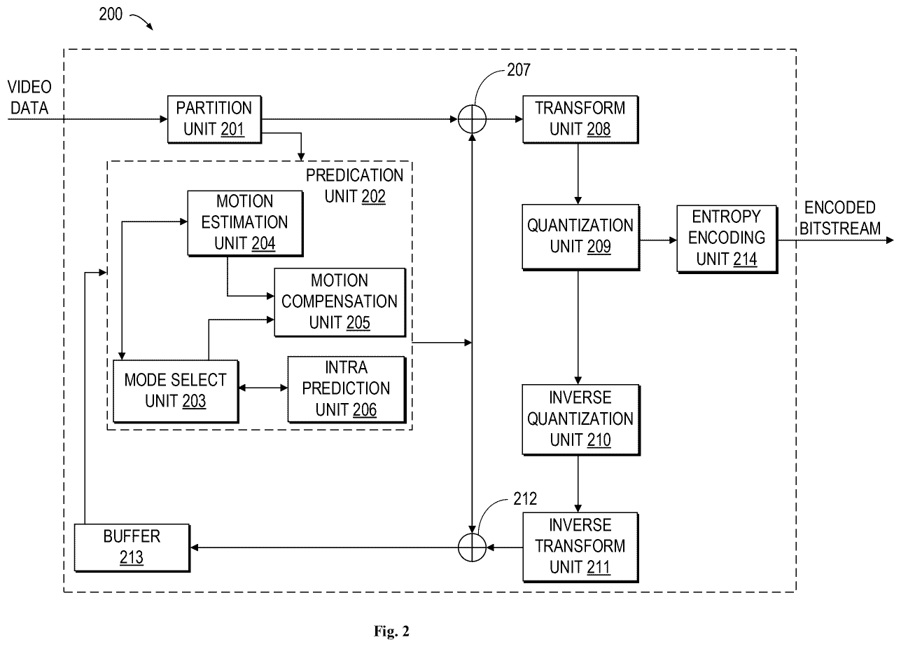

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

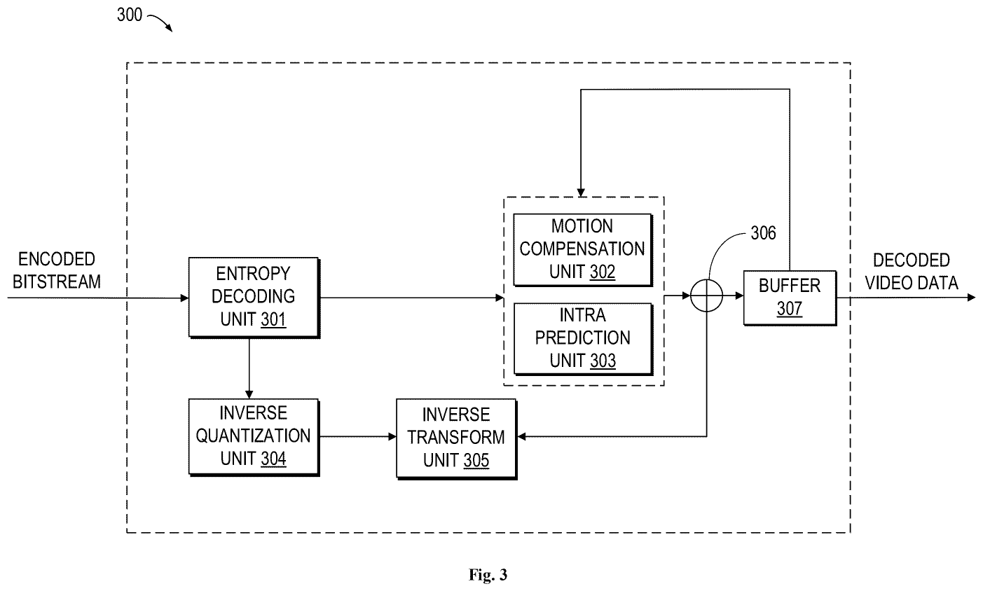

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video/image coding technologies. Specifically, it is related to bi-directional optical flow. It may be applied to the existing video coding standard like HEVC, VVC, or the next generation video coding standard like beyond VVC exploration such as ECM. It may also be applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. As of July 2020, it has also finalized the Versatile Video Coding (VVC) standard, aiming at yet another 50% bit-rate reduction and providing a range of additional functionalities. After finalizing VVC, activity for beyond VVC has started. A description of the additional tools on top of the VVC tools has been summarized in M. Coban, F. Léannec, K. Naser, and J. Strom “Algorithm description of Enhanced Compression Model 5 (ECM 5),” document JVET-Z2025, 26th JVET meeting: by teleconference, 20-29 Apr. 2022, and its reference SW is named as ECM.

### 2.1 Bi-Directional Optical Flow (BDOF) in VVC

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are First, the horizontal and vertical gradients computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)}(i, j) are the sample value at coordinate (i, j) of the prediction signal in list k, k=0,1, and shift1 is calculated based on the luma bit depth, bitDepth, as shift1=max (6, bitDepth-6). Then, the auto- and cross-correlation of the gradients, S₁, S₂, S₃, S₅ and S₆, are calculated as:

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min (1, bitDepth-11) and min (4, bitDepth-8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where S_{2,m}=S₂>>nₛ_{₂}, S_{2,s}=S₂&(2ⁿ^{ₛ₂}−1),

$${th}_{BIO}^{′} = {2}^{max ( 5 , BD - 7 )} .$$

└·┘ is the floor function, and nₛ_{₂}=12. Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift$$

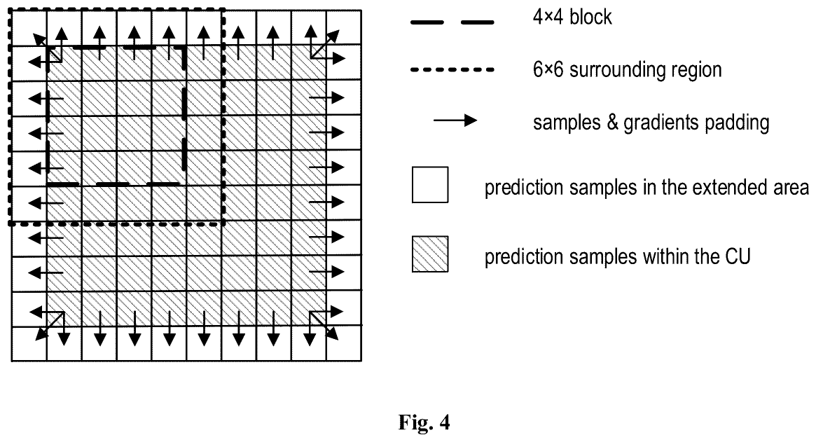

These values are selected such that the multipliers in the BDOF process do not exceed 15-bit, and the maximum bit-width of the intermediate parameters in the BDOF process is kept within 32-bit. In order to derive the gradient values, some prediction samples I^{(k)}(i, j) in list k (k=0,1) outside of the current CU boundaries need to be generated. As depicted in FIG. 4, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.1 BDOF in ECM: Sample-Based BDOF

In the sample based BDOF, instead of deriving motion refinement (vₓ, v_{y}) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive vₓ and v_{y}. The derived motion refinement (vₓ, v_{y}) is applied to adjust the bi-predicted sample value for the center sample of the window.

### 2.2 Decoder Side Motion Vector Refinement (DMVR) in VVC

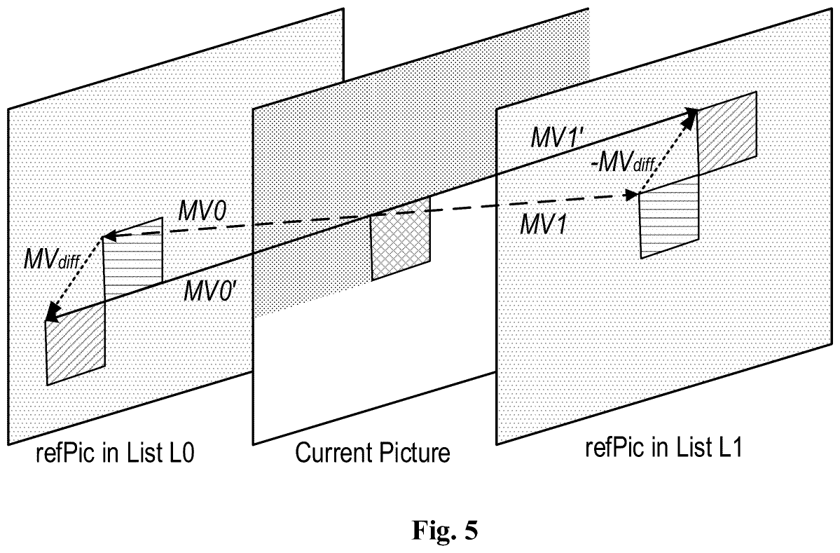

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 5, the SAD between the red blocks based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV.
One reference picture is in the past and another reference picture is in the future with respect to the current picture.
The distances (i.e., POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

In DVMR, the search points are surrounding the initial MV and the MV offset obey the MV difference mirroring rule. In other words, any points that are checked by DMVR, denoted by candidate MV pair (MV0, MV1) obey the following two equations.

$$MV {0}^{′} = MV 0 + MV\_offset$$

$$MV {1}^{′} = MV 1 - MV\_offset$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples. When the width and/or height of a CU are larger than 16 luma samples, it will be further split into subblocks with width and/or height equal to 16 luma samples. The maximum unit size for DMVR searching process is limit to 16×16.

### 2.3. Multi-Pass Decoder-Side Motion Vector Refinement (ECM)

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.3.1 First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV ,$$

$$MV1\_pass1 = MV 1 - deltaMV .$$

### 2.3.2 Second Pass—Subblock Based Bilateral Matching MV Refinement

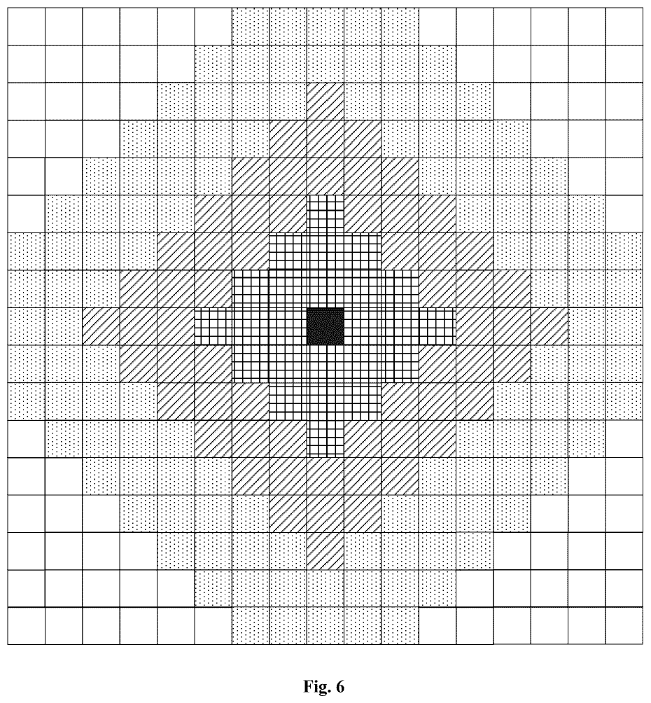

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1. For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8. The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 6. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates. The existing VVC DMVR fractional sample refinement is further applied to derive the final deltaMV (sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 ) .$$

### 2.3.3 Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled vₓ and v_{y} without clipping starting from the refined MV of the parent subblock of the second pass. The derived bioMv(vₓ, v_{y}) is rounded to 1/16 sample precision and clipped between −32 and 32.

The refined MVs (MV0_pass3 (sbIdx3) and MV1_pass3 (sbIdx3)) at third pass are derived as:

$$MV0\_pass3 ( sbIdx 3 ) = MV0\_pass2 ( sbIdx 2 ) + bioMv ,$$

$$MV1\_pass3 ( sbIdx 3 ) = MV0\_pass2 ( sbIdx 2 ) - bioMv .$$

In all aforementioned sub-clauses, when wrap around motion compensation is enabled, the motion vectors shall be clipped with wrap around offset taken into consideration.

### 2.3.4 Adaptive Decoder-Side Motion Vector Refinement

Adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1^{st} pass (i.e., PU level) DMVR.

The merge candidates for the new merge mode are derived from spatial neighboring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### 3. Problems

There are several parts in the BDOF MV refinement/sample adjustment may be improved.
The current formulas which is used to drive BDOF parameters, are not accurate formulas.
There are no weights to indicate the importance of each sample in the final formula.
There is no filtering process to smooth out the final derived MV refinement/sample adjustment.
There is no clear distinction for conditions of applying BDOF for MV refinement/sample adjustment.

Similarly, no distinction for their formula.

### 4. Detailed Solutions

The detailed solutions below should be considered as examples to explain general concepts. These solutions should not be interpreted in a narrow way. Furthermore, these solutions can be combined in any manner. The methods disclosed below may be applied to bi-directional optical flow, decoder side motion vector refinement, and any extensions of them.

### On BDOF MV Refinement Parameter Derivation

In the following section general equation for deriving BDOF parameters (vx and vy) is defined as:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6 ,$$

where, Gx and Gy represents summation of horizontal and vertical gradients for 2 reference pictures, respectively. dI represents the difference between 2 reference pictures. Summations (Σ) are inside of the predefined area, which could be an N×M block around current sample (for sample adjustment BDOF), or around the current prediction subblock (for MV refinement BDOF).
1. It is proposed that a method of deriving gradients different to that of BDOF in VVC may be used to calculate horizontal and/or vertical gradients.
   a. In one example gradients are computed by directly calculating the difference between two neighboring samples, i.e.,

$$\frac{\partial {I}^{( k )}}{\partial x} ( i , j ) = ( ( {I}^{( k )} ( i + 1 , j ) ≫ 1 ) - ( {I}^{( k )} ( i - 1 , j ) ≫ 1 ) )$$

$$\frac{\partial {I}^{( k )}}{\partial y} ( i , j ) = ( ( {I}^{( k )} ( i , j + 1 ) ≫ 1 ) - ( {I}^{( k )} ( i , j - 1 ) ≫ 1 ) )$$

b. In another example gradients are computed by calculating the difference between two shifted neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) )$$

$$\frac{\partial {I}^{( k )}}{\partial y} ( i , j ) = ( ( {I}^{( k )} ( i , j + 1 ) ≫ shift 2 ) - ( {I}^{( k )} ( i , j - 1 ) ≫ shift 2 ) )$$

i. shift1 and shift2 may be any integers such as 0, 1, 2, 6, . . . or even negative integers.
   c. In another example gradients may be calculated with Nb samples before and Na samples after current samples as a weighted sum:

$$\frac{\partial {I}^{( k )}}{\partial x} ( i , j ) = {\sum }_{p = - Nb}^{Na} wp * {I}^{( k )} ( i + p , j )$$

$$\frac{\partial {I}^{( k )}}{\partial y} ( i , j ) = {\sum }_{p = - Nb}^{Na} wp * {I}^{( k )} ( i , j + p )$$

i. Weights, i.e., wp, may be any integer number such as −6, 0, 2, 7 . . . or any real number such as −6.3, −0.77, 0.1, 3.0, . . . .
   ii. Weights for calculating horizontal and vertical gradients may be different from each other.
      (i) Alternatively, the weights for calculating horizontal and vertical gradients may be the same.
      iii. Weights may be signaled from an encoder to a decoder.
      iv. Weights may be derived using information decoded.
      v. Nb and Na may be any integer numbers such as 0, 3, 10, . . . .
      vi. Nb and Na may be different for calculating gradients for horizontal and vertical directions.
         (i) Alternatively, they may be the same for calculating gradients for both horizontal and vertical directions.
      vii. In one example,

$$\frac{\partial {I}^{( k )}}{\partial x} ( i , j ) = ( {\sum }_{p = - Nb}^{Na} wp * {I}^{( k )} ( i + p , j ) + Offset ) ≫ shift$$

$$\frac{\partial {I}^{( k )}}{\partial y} ( i , j ) = ( {\sum }_{p = - Nb}^{Na} wp * {I}^{( k )} ( i , j + p ) + Offset ) ≫ shift$$

(i) alternatively, furthermore, the variable offset may be set to 0, or (1<< (shift-1)).
2. It is proposed that a complete linear equation formula may be used to derive the final MV refinement.
   a. In one example after calculating all the gradients, s1, s2, s3, s5, and s6 are calculated as explained above:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6.$$

i. In one example, to derive the final MV of a M*N block, samples in a (M+K1)*(N+K2) region around the original block may be involved. For example, K1 and K2 may be any integer numbers such as 0, 2, 4, 7, 10, . . . .
   b. In one example after calculating all the s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. In one example shTem maybe any integer number such as 0, 1, 3, . . . .
   c. In one example after calculating D, Dx, and Dy; vₓ and v_{y} may be derived as:

$$vx = Dx / D and vy = Dy / D .$$

i. In another example if abs (D) is smaller than a predefined threshold, C, vₓ and v_{y} are set to zero. C may be any non-negative number such as 0, 10, 17, . . . .
   d. In one example any amount of the shifts and clipping may be involved to derive the final vₓ and v_{y}.
      i. In one example the numerator and/or denominator, may have an extra shift, in a way that overall, it is left shifted by K so that the final derived vₓ and v_{y} have higher precision. K may be any integer number such as 0, 1, 3, 4, 6, . . . .
      ii. In one example these shifts may come in any order, such as having the shifts at the beginning, and/or having the shift for intermediate variables and/or having the shift on the final MVs
      iii. In one example the final vₓ and v_{y} may be clipped between-B and B, where B may be any integer number such as 2, 10, 17, 32, 100, 156, 725, . . . .
   e. In one example the final vₓ and v_{y} may be multiplied (or similarly divided) by a number before getting used for motion compensation procedure.
      i. In one example vₓ and v_{y} may be multiplied by R, where R is any real number, such as 1.25, 2, 3.1, 4, . . . .
      ii. In another example vₓ and v_{y} may be divided by R, where R is any real number, such as 1.25, 2, 3.1, 4, . . . .
      iii. In one example the value of the number to multiply (or divide) the final vₓ, v_{y} with may be different for vₓ and v_{y}.
      iv. In one example the value of the number to multiply (or divide) the final vₓ, v_{y}, may depend on the block size, sequence resolution, block characteristics, and so on.
3. It is proposed that a partial linear equation solution may be used to derive the final MV refinement.
   a. In one example after calculating all the gradients, s1, s2, s3, s5, and s6 are calculated as explained above:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6.$$

b. In one example after calculating all the s1, s2, s3, s5, and s6, approximated version of vₓ and v_{y} may be calculated as:

$$vx = s 3 / s 1 ,$$

$$vy = ( s 6 - s 2 * vx ) / s 5.$$

c. In another example after calculating vₓ similar to above, partial amount of the vₓ may be put in the second formula to derive the v_{y}.
   i. In one example v_{y} may be derived as v_{y}=(s6-s2*vₓ/T)/s5, where T may be any real number such as 1.1, 2, 4, . . . .
   d. In one example after calculating all the s1, s2, s3, s5, and s6, approximated version of vₓ and v_{y} may be calculated as:
      Assume vₓ is zero: v_{y}=s6/s5,
      Insert v_{y} in the first formula: vₓ=(s3−s2*v_{y})/s1.
   e. In another example after calculating v_{y} similar to above, partial amount of the v_{y} may be inserted in the second formula to derive the vₓ.
      i. In one example vₓ may be derived as vₓ=(s3−s2*v_{y}/T)/s1, where T may be any real number such as 1.1, 2, 4, . . . .
   f. In one example after calculating all the s1, s2, s3, s5, and s6, approximated version of vₓ and v_{y} may be calculated as:
      Assume v_{y} is zero: vₓ=s3/s1.
         Assume vₓ is zero: v_{y}=s6/s5.
4. It is proposed that a simplified solution may be used to derive the final MV refinement.
   a. In one example the method explained in the background section for VVC BDOF may be used to derive the approximated version of s1, s2, s3, s5, and s6.
   b. In one example after calculating approximated version of the s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. In one example after calculating D, Dx, and Dy; vx and vy may be derived as:

$$vx = Dx / D and vy = Dy / D .$$

ii. In one example shTem maybe any integer number such as 0, 1, 3, . . . .
   c. In one example after calculating approximated version of the s1, s2, s3, s5, and s6, approximated version of vₓ and v_{y} may be calculated as:
      Assume v_{y} is zero: vₓ=s3/s1,
      Substitute vₓ in the second formula: v_{y}=(s6-s2*vₓ)/s5.
      i. Or alternatively, a modified vₓ may be inserted in the second formula:
         v_{y}=(s6-s2*vₓ/T)/s5, where T may be any real number such as 1.1, 2, 4, . . . .
      ii. Alternatively, first vₓ may be assumed zero, and v_{y} may be derived, after that either v_{y} or a scaled version of it may be inserted into the first equation and vₓ may be derived.
5. It is proposed any combination of the methods explained above may be used to derive the final MV refinement.
   a. In one example any combination of the methods explained above (2, 3, and 4) may be combined and used together.

### On BDOF Sample Adjustment Parameter Derivation

6. It is proposed that any of the method explained above for BDOF MV refinement may also be used for BDOF sample adjustment parameter derivation.
   a. In one example after calculating all the gradients, s1, s2, s3, s5, and s6 are calculated as explained above:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6.$$

i. In one example samples in a K×K region around the sample may be involved in the derivation. K may be any integer number such as 1, 3, 4, 5, 7, 10, . . . .
   b. In one example after calculating s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. shTem maybe any integer number such as 0, 1, 3, . . . .
   ii. In one example after calculating D, Dx, and Dy; vx and vy may be derived as:

$$vx = Dx / D and vy = Dy / D .$$

iii. In another example if abs (D) is smaller than a predefined threshold, C, vx and vy are set to zero. C may be any non-negative number such as 0, 10, 17, . . . .
   c. In one example after calculating s1, s2, s3, s5, and s6, approximated version of vx and vy may be calculated as:

$$vx = s 3 / s 1 ,$$

$$vy = ( s 6 - s 2 * vx ) / s 5.$$

i. Or alternatively a modified vx may be put in the second formula:

$$vy = ( s 6 - s 2 * vx / T ) / s 5 ,$$

ii. Alternatively, first vx may be assumed zero, and vy may be derived, after that either vy or a scaled version of it may be substituted into the first equation and vx may be derived.
   d. In one example the method explained in the background section for VVC BDOF may be used to derive the approximated version of s1, s2, s3, s5, and s6.
   e. In one example the final vx and vy may be multiplied (or divided or shifted) by a number before getting used for sample adjustment procedure.
      i. In one example vx and vy may be multiplied by R, where R is any real number, such as 1.25, 2, 3.1, 4, . . . .
      ii. In another example vx and vy may be divided by R, where R is any real number, such as 1.25, 2, 3.1, 4, . . . .
      iii. In one example the value of the number to multiply (or divide) the final vx, vy with may be different for vx and vy.
      iv. In one example the value of the number to multiply (or divide) the final vx, vy, may depend on the block size, sequence resolution, block characteristics, position in the block, and so on.

### On Applying Weights in Parameter Derivation

7. It is proposed that any weights may be applied before adding BDOF intermediate parameters for MV refinement.
   a. In one example during adding parameters to get s1, s2, s3, s5, and s6, inside of the target region of Ω(a M_ext*N_ext region around the current block), all the values are added with similar weight (of 1).
   b. In another example during adding parameters to get s1, s2, s3, s5, and s6, inside of the target region of Ω(a M_ext*N_ext region around the current block), the values are added after being multiplied with a predefined weight depending on their position in the extended block (target region of Ω).
   c. In one example these predefined weights are defined as:

$$w = ( x >= ( width / 2 ) ? width - x : x + 1 ) * ( y >= ( height / 2 ) ? height - y : y + 1 )$$

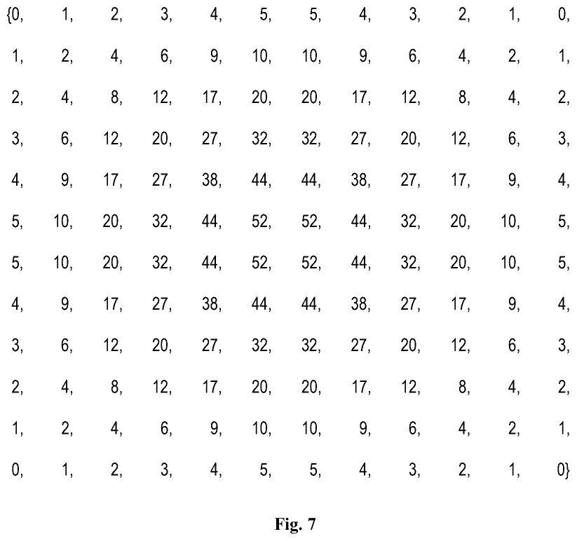

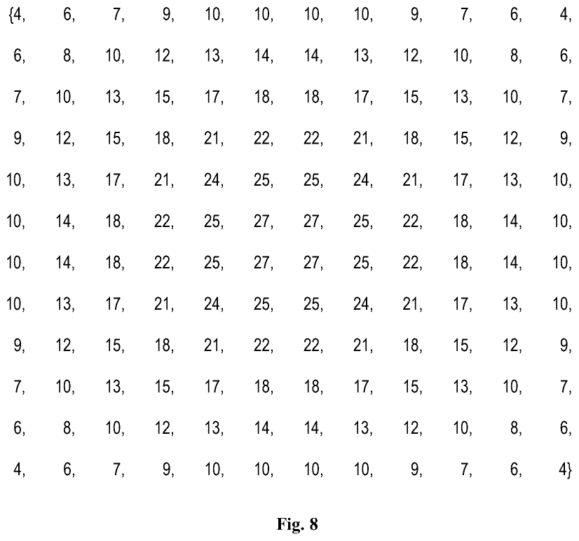

for x from 0 to width-1 and y from 0 to height-1.
   Width and height represent the width and height of the target region.
   d. In another example these predefined weights may be generated with some known probability distribution such as Gaussian distribution with any value of the standard deviations (σ=1, 1.5, 4, or any other real number) and center position.
      i. In one example these weights are generated with Gaussian distribution with σ=2.5 for a 12×12 region as depicted in FIG. 7.
      ii. In one example these weights are generated with Gaussian distribution with σ=4 for a 12×12 region as depicted in FIG. 8.
   e. In another example during adding parameters to get s1, s2, s3, s5, and s6, inside of the target region of Ω(a M_ext*N_ext region around the current block), the values are added after being shifted with a predefined values depending on their position in the extended block (target region of Ω).
   f. In one example the weight matrix may be represented as left (or right) shift matrix, and depending on the matrix entries, the data gets shifted (left or right) before summation.
8. In one example depending on the block size, block shape, block characteristics, sequence resolutions, and so, different weights may be applied.
   i. Or alternatively depending on the block size, block shape, block characteristics, sequence resolutions, and so on, no weight may be applied.
   ii. The weight matrix may be coded explicitly in sequence parameter set (SPS), picture parameter set (PPS), or slice header (SH).
9. It is proposed that any weights may be applied before adding BDOF intermediate parameters for sample adjustment.
   a. In one example during adding parameters to get s1, s2, s3, s5, and s6, inside of the target region of Ω(a K1*K2 region around the current sample), all the values are added with similar weight (of 1). K1 and K2 may be any integer number such as 1, 2, 3, 5, 8, . . . .
   b. In another example during adding parameters to get s1, s2, s3, s5, and s6, inside of the target region of Ω(a K1*K2 region around the current sample), the values are added after being multiplied with a predefined weight depending on their position in the extended block (target region of Ω).
   c. In one example these predefined weights are defined as:

$$w = ( x >= ( K 1 / 2 ) ? K 1 - x : x + 1 ) * ( y >= ( K 2 / 2 ) ? K 2 - y : y + 1 ) ,$$

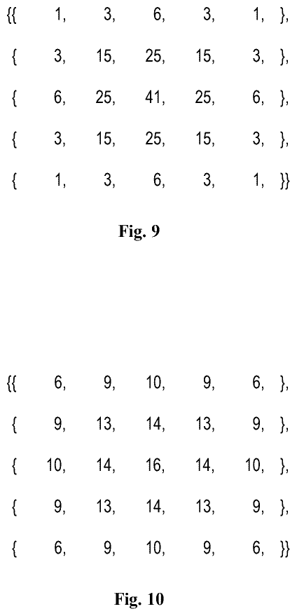

for x from 0 to K1-1 and y from 0 to K2-1.
   K1 and K2 represent the width and height of the target region.
   d. In another example these predefined weights may be generated with some known probability distribution such as Gaussian distribution with any value of the standard deviations (σ=1, 1.5, 2, 4, or any other real number) and any center position.
      i. In one example these weights are generated with Gaussian distribution with σ=1 for a 5×5 region as depicted in FIG. 9.
      ii. In one example these weights are generated with Gaussian distribution with σ=2 for a 5×5 region as depicted in FIG. 10.
   e. In one example the weight matrix may be represented as a left (or right) shift matrix, and depending on the matrix entries, the data gets shifted (left or right) before summation.
   f. In one example depending on the block size, block shape, block characteristics, sequence resolutions, and so, different weights may be applied.
      i. Or alternatively depending on the block size, block shape, block characteristics, sequence resolutions, and so on, no weight may be applied.

### On Applying Filters on the Final MV Refinement or Sample Adjustment

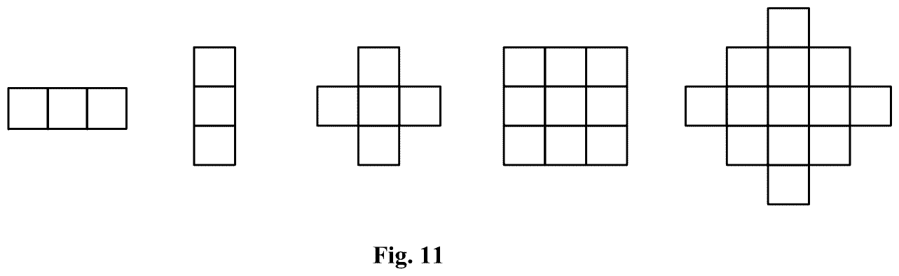

10. It is proposed that any type of the filters may be applied on the final derived MV refinement (vx and vy). Some examples are depicted in FIG. 11.
   a. In one example any smoothing filter of any shape may be applied on all the MVs derived by BDOF for each subblock.
   b. In one example during filter application all the MVs inside of the PU may be used.
   c. In another example during filter application, only MVs with similar 2^{nd} round of DMVR MVs, may be used for those MVs.
   d. In one example a shape filter with any weights may be applied on the MVs.
      i. In one stance the weight for the center may be 8, and the weight for 4 sides may be 1.
      ii. In one stance the weight for the center may be 4, and the weight for 4 sides may be 1.
      iii. In one stance the weight for the center may be 4, and the weight for 4 sides may be 2.
      iv. In one stance the weight for the center may be 4, and the weight for 4 sides may be 3.
      v. In one stance the weight for the center may be 1, and the weight for 4 sides may be 1.
11. It is proposed that any type of the filters may be applied on the final derived BDOF sample MV adjustment, or final sample adjustment. Some examples are depicted in FIG. 11.
   a. In one example filter is applied on all (vx,vy) s or final adjustment inside of the subblock.
   b. In one example, a shape filter with any weights may be applied on the (vx,vy) s or final adjustment.
      i. In one stance the weight for the center may be 8, and the weight for 4 sides may be 1.
      ii. In one stance the weight for the center may be 4, and the weight for 4 sides may be 1.
      iii. In one stance the weight for the center may be 4, and the weight for 4 sides may be 2.
      iv. In one stance the weight for the center may be 4, and the weight for 4 sides may be 3.
      v. In one stance the weight for the center may be 1, and the weight for 4 sides may be 1.

### On Conditions for Applying BDOF

12. It is proposed that there may be a condition on applying BDOF MV refinement or BDOF sample adjustment.
   a. In one example the condition of applying BDOF MV refinement may be similar to the condition of applying BDOF sample adjustment.
   b. In another example, the condition of applying BDOF MV refinement may be different of the condition of applying BDOF sample adjustment. For example, BDOF MV refinement may be applied to bi-prediction coded CU with un-equal weight, while BDOF sample adjustment may only be applied to bi-prediction coded CU with equal weight.
13. It is proposed that the cost for evaluating the BDOF condition may depend on a cost between 2 reference picture blocks.
   a. In one example different cost functions may be used to derive the cost.
      i. In one example this cost may be Sum of Absolute Difference (SAD) between the 2 reference picture blocks.
      ii. In one example this cost may be Sum of Absolute Transformed Difference (SATD) or any other cost measure between the 2 reference picture blocks.
      iii. In one example this cost may be Mean Removal based Sum of Absolute Difference (MR-SAD) between the 2 reference picture blocks.
      iv. In one example this cost may be a weighted average of SAD/MR-SAD and SATD between the 2 reference picture blocks.
      v. In one example, the cost function between 2 reference picture blocks may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.

### On BDOF MV Refinement Subblock Size

14. It is proposed any subblock size, depending on the conditions, may be used as BDOF MV refinement subblock size.
   a. In one example subblock size may be a fixed size such as N×M, where N and M could be any positive integer, such as 1, 2, 3, 4, 5, 8, 12, 32, . . . .
   b. In another example subblock size may depend on the current PU, or CU size. As an example, for block size W×H, subblock size of W1×H1 may be used, where W1 and H1 depend on W and H, and could be any positive integer number.
      i. In one example for blocks with number of samples (i.e., width times height (W*H)) between C_i and C_(i+1), subblock size of W_i×H_i may be used. C_i s could be any non-negative number such as 0, 4, 20, 128, 256, 951, 2048, 4100, . . . and W_i×H_i may be any positive integer pairs such as 2×2, 4×4,8×4, 4×8, 8×8, 16×16, 19×15, . . . .
      ii. In one example for blocks with width W, between Cw_i and Cw_(i+1), and height H, between Ch_j and Ch_(j+1), subblock size of W_i×H_j may be used. Cw_i and Ch_j s could be any non-negative numbers such as 0, 4, 20, 128, 256, 951, 2048, 4100, . . . and W_i×H_j may be any positive integer pairs such as 2×2, 4×4,8×4, 4×8, 8×8, 16×16, 19×15, . . . .
   c. In one example, the subblock size may depend on the color component and/or color format.
   d. In one example subblock size may depend on the coded information of current block.
      i. In one example, the coded information is the residual information.
      ii. In one example, the coded information is the coding tool that is applied to current block.
   e. In one example subblock size may depend on the information of prediction blocks.
   f. In one example subblock size may depend on the reference pictures characteristics.
      i. In one example, subblock size may be determined by the similarity of two predictors from two reference pictures. If two predictors are similar, such as SAD between these two predictors is small, the larger subblock size may be applied; Otherwise, the small subblock size may be applied.
      ii. In one example, subblock size may be determined by the distribution of the difference between two predictors. Those subblocks with difference energy, such as SAD or SSE, may be merged to a larger unit for MV refinement to reduce the computation complexity.
   g. In one example subblock size may depend on the temporal gradient of the 2 reference blocks.
      i. In one example any cost function such as SAD, may be used for calculating the 2 reference block gradients (or differences).
   h. In one example the spatial gradients of the reference blocks may be used to determine the subblock size.
   i. In one example the subblock size may depend on the Quantization Parameter (qp) value.
      i. In one example for qp less than X, the subblock size of W_X×H_X may be used.
      ii. In one example for qp greater than X, the subblock size of W_X×H_X may be used.
      iii. In one example for qp X, the subblock size of W_X×H_X may be used.
      iv. In one example X may be any non-negative integer such as 10, 22, 27, 32, 37, 42, . . . and W_X and H_X may be any positive integer such as 1, 2, 3, 4, 8, 10, . . . .
      v. In one example, qp can be the qp of current CU, or the qp of current slice, or the qp of the whole sequence.
      vi. In one example the decision for subblock size may be a encoder decision and it may or may not be signaled to the decoder. Similarly, it may be a decoder decision.
      vii. In one example increasing or decreasing the subblock size based on qp, may be an encoder or decoder decision.
   j. In one example the subblock size may depend on the prediction type.
   k. In one example the subblock size my depend on the DMVR first and/or 2^{nd} stage adjustment value.
   l. In one example the subblock size may depend on the sequence resolution.
   m. In one example the subblock size may depend on the coding tools applied to current block.
   n. In one example the subblock size may depend on the temporal layers.
      i. In one example for temporal layers between Ti and Tj, subblock size of W_ij×H_ij may be used. Ti, Tj may be any non-negative integer such as 0, 1, 3, 4, . . . , and W_ij, H_ij may be any positive integer such as 2, 4, 6, 16, . . . .
   o. In one example the subblock size may be a function of all or some of the parameters mentioned above.
   p. In above examples, the subblock size of luma and/or chroma blocks may be determined according to above examples.
      i. Alternatively, the subblock size for chroma blocks may be derived according to that for luma blocks and color format and/or separate plane coding enabled or not.

### On Asymmetric BDOF

15. It is proposed the MV adjustment for the first list and second list may not be symmetric.
   a. In one example the MV refinement for ref pic 0, may be (vx0, vy0) and the MV refinement for ref pic 1, may be (−vx1, −vy1), where vx0, vy0, vx1, vy1 may be any real or integer numbers. They may or may not have relationship together.
   b. In one example general equations for deriving vx0, vy0, vx1, vy1 may be written as following 4 equations:

$$\sum Gx 0 \cdot Gx 0 * vx 0 + \sum Gx 1 \cdot Gx 0 * vx 1 + \sum Gy 0 \cdot Gx 0 * vy 0 + \sum Gy 1 \cdot Gx 0 * vy 1 = \sum dI \cdot Gx 0.$$

$$\sum Gx 0 \cdot Gx 1 * vx 0 + \sum Gx 1 \cdot Gx 1 * vx 1 + \sum Gy 0 \cdot Gx 1 * vy 0 + \sum Gy 1 \cdot Gx 1 * vy 1 = \sum dI \cdot Gx 1.$$

$$\sum Gx 0 \cdot Gy 0 * vx 0 + \sum Gx 1 \cdot Gy 0 * vx 1 + \sum Gy 0 \cdot Gy 0 * vy 0 + \sum Gy 1 \cdot Gy 0 * vy 1 = \sum dI \cdot Gy 0.$$

$$\sum Gx 0 \cdot Gy 1 * vx 0 + \sum Gx 1 \cdot Gy 1 * vx 1 + \sum Gy 0 \cdot Gy 1 * vy 0 + \sum Gy 1 \cdot Gy 1 * vy 1 = \sum dI \cdot Gy 1.$$

where, Gx0, Gx1, Gy0 and Gy1 represents horizontal gradients for ref pic 0, horizontal gradients for ref pic 1, vertical gradients for ref pic and vertical gradients for ref pic 1 respectively. dI represents the difference between 2 reference pictures. Summations (Σ) are inside of the predefined area, which could be an N×M block around current sample (for sample adjustment BDOF), or around the current prediction subblock (for MV refinement BDOF).
   c. Alternatively in a matrix format they may be written as:

$$[ \begin{matrix}{s}_{00} & {s}_{01} & {s}_{02} & {s}_{03} \\ {s}_{10} & {s}_{11} & {s}_{12} & {s}_{13} \\ {s}_{20} & {s}_{21} & {s}_{22} & {s}_{23} \\ {s}_{30} & {s}_{31} & {s}_{32} & {s}_{33}\end{matrix} ] * [ \begin{matrix}vx 0 \\ vx 1 \\ vy 0 \\ vy 1\end{matrix} ] = [ \begin{matrix}S 0 \\ S 1 \\ S 2 \\ S 3\end{matrix} ]$$

where the parameters in the matrix format is matched with the parameters in the equations.
   d. In one example determinant general formula may be used to solve the above linear equations.
   e. In one example Gaussian elimination approach may be used to solve the above linear equations.
   f. In one example any other method, including matrix decomposition may be used to solve the above linear equations.
   g. In one example vx1 may equal k*vx0 and vy1 may equal k*vy0, and k may be any real or integer number such as −0.3, 0, 0.1, 2, 3, . . . .
      i. In one example any nonlinear method may be used to derive and solve the nonlinear equation.
   h. In one example any weighted sum described in the previous sections may be used for the summation.
   i. In one example asymmetric BDOF may be applied for both BDOF MV refinement as well as BDOF sample adjustment.
   j. In one example asymmetric BDOF may be applied only for the BDOF MV refinement.
   k. In one example asymmetric BDOF may be applied only for the BDOF sample adjustment.
   l. In one example, whether to and/or how to apply asymmetric BDOF may depend on POC or at least one POC distance.
      i. In one example, whether to and/or how to apply asymmetric BDOF may depend on |POC_ref0−POC_cur| and/or |POC_ref1−POC_cur|, wherein POC_ref0 and POC_ref1 represent the POC of two reference pictures and POC_cur is the POC of the current picture.
   m. In one example, whether to and/or how to apply asymmetric BDOF may depend on BCW weights.
   n. In one example, whether to and/or how to apply asymmetric BDOF may depend on at least one template of the current block.
      i. Furthermore, whether to and/or how to apply asymmetric BDOF may depend on at least one reference template of the template of the current block.
         On Condition of Applying BDOF and its Combination with Other Tools
16. It is proposed BDOF and/or asymmetric BDOF (MV refinement or sample adjustment or both) may be used in combination or excluded with other tools.
   a. In one example BDOF may be applied for the blocks coded with non-equal BCW weight.
      i. In one example BDOF may be applied with BCW weights from a predefined set, such as {3}, or {3, 5} or {−1, 3}.
   b. In one example BDOF may be applied for the blocks with both reference pictures on the same side of the current frame.
   c. In one example BDOF may be applied for the blocks with reference pictures on the opposite side of the current frame.
      i. In one example they may have the same distance to the current frame.
      ii. In another example they may have different distance from the current frame.
   d. In one example the BDOF may be applied in combination with LIC.
      i. Alternatively, it may be off if block uses LIC.
   e. In one example the BDOF may be applied in combination with OBMC.
      i. Alternatively, it may be off if block uses OBMC.
   f. In one example the BDOF may be applied in combination with CCIP.
      i. Alternatively, it may be off if block uses CIIP.
   g. In one example the BDOF may be applied in combination with SMVD.
      i. Alternatively, it may be off if block uses SMVD.
   h. In one example, BDOF DMVR or BDOF sample may be controlled separately. For example, the BDOF DMVR is applied, but BDOF sample is not applied.
      i. The controlling can be at sub-PU level, or at CU level, or at CTU level.
         On Merging Subblocks with Similar MV Before Applying BDOF DMVR or BDOF Sample
17. It is proposed that multiple subblocks may share the same MV after/before a MV refinement process such as BDOF or DMVR.
   a. In one example, it is proposed to check for similar MVs for neighboring subblocks, and combining them before applying BDOF DMVR or BDOF sample process.
   b. In one example, multiple subblocks sharing the same MV may perform motion compensation as a whole.
   c. In one example N1 neighbor subblocks in one row with similar MVs may be merged.
      i. N1 may be any integer number such as 2, 3, 4, 10,
   d. In one example N2 neighbor subblocks in one column with similar MVs may be merged.
      i. N2 may be any integer number such as 2, 3, 4, 10,
   e. In one example all the neighbor subblocks in one row till rth (first, second, . . . ) round of the DMVR sub-PU boundaries, with similar MVs may be merged. These sub-PU boundaries may happen every K pixel, where K may be any integer number such as 8, 16, 19, 32, . . . .
   f. In one example all the neighbor subblocks in one column till rth (first, second, . . . ) round of the DMVR sub-PU boundaries, with similar MVs may be merged. These sub-PU boundaries may happen every K pixel, where K may be any integer number such as 8, 16, 19, 32, . . . .
   g. In one example decision to merge row based or column based, may depend on the block size width (W) and/or height (H).
      i. In one example if W>=H, row-based merging approach may be used. Otherwise, column-based merging approach may be used.
      ii. Alternatively, if W<H, row-based merging approach may be used. Otherwise, column-based merging approach may be used.
   h. In one example for each subblocks inside of a bigger M×N subblock, the MV checking and merging process may be applied. M and N may be any integer such as 4, 5, 10, 16, 32, . . . .
      i. In one example all 4×4 (or 8×8) subblocks inside of a 16×16 or 8×8 or 16×8 or 32×32 may be merged.
      ii. In one example these M and N may be variable or may be fixed.
   i. In one example all the subblocks inside of a PU or CU may be merged.
   j. In one example, in all the above scenarios, subblocks with almost similar MVs (and not necessarily identical) may be merged too. Almost similar criteria may be defined as if the first order, or second order Euclidian distance of the MVs are smaller than a threshold. The merged MV, may be the average, mode, . . . of all the MVs. Or it could be center or top left or bottom right, or other position's MV.
   k. Alternatively, furthermore, when two subblocks with similar motion, the motion information of one or both subblocks may be modified before being used such that the two subblocks will use the same motion for the preceding operations.
   l. In one example, when two motion use the same reference pictures and MVs are similar (e.g., MV differences is smaller than a threshold), they are treated as similar motions.
   m. The above examples may be applied for each prediction direction.
      i. Alternatively, they may be applied for all prediction directions together.

### On Parallelization, Code Optimization, and Applying Shifts for BDOF

18. It is proposed to apply parallelization for calculating BDOF parameters.
   a. In one example all the related functions' SIMD implementation may be used.
   b. In one example during calculating the sum of the parameters for BDOF sample (or DMVR), K sums of samples' sum at one iteration may be derived. K may be any integer such as 2, 3, 4, 5, 8, . . . .
   c. In one example the weighted sums, may be implemented as proper left shifts.
      i. In one example multiplication with weight w_i may be replaced with left shift of log 2 (1+w_i).
19. It is proposed to have several code optimizations for BDOF.
   a. In one example BDOF DMVR parameters would not be calculated all the time. Its calculation may be delayed and be conditioned if it is actually needed.
      i. In one example it will only be calculated if no BDOF sample is applied.
   b. In one example BDOF sample parameters would not be calculated all the time. Its calculation may be delayed and be conditioned if it is actually needed.
      i. In one example it will only be calculated if BDOF DMVR stage, resulted in no MV update.
      ii. In one example it will only be calculated if no BDOF DMVR is applied.
   c. In one example for the blocks with BDOF DMVR off, a different subblock size may be used to check BDOF sample applying conditions.
      i. In one example this new subblock size may be bigger or smaller than the BDOF DMVR subblock size. It may be M×N, where M and N may be any integer numbers. Here are some examples for M×N sizes: 2×2, 4×4, 4×8, 8×4, 8×8,
20. It is proposed to add shifts (right or left) at different stage of BDOF parameter derivation in order to remove noise, or avoid overflow, or reduce the bandwidth of the data, or increase accuracy of the derived parameters.
   a. A shift operation may be a right shift or a left shift.
   b. An offset may be added before and/or after the shifting operation.
   c. The shifted results may be clipped to a range.
   d. In one example the data may be shifted by Shift1 before/after calculating gradients. Shift1 maybe any right shift or left shift with any integer value such as 0, 1, 3, 4, 6, . . . .
   e. In one example the data may be shifted by Shift2 before/after calculating difference of luminance. Shift2 maybe any right shift or left shift with any integer value such as 0, 1, 3, 4, 6, . . . .
   f. In one example the data may be shifted by Shift3 before/after multiplying the gradients or luminance differences. Shift3 maybe any right shift or left shift with any integer value such as 0, 1, 3, 4, 6, . . . .
   g. In one example the data may be shifted by Shift4 before/after calculating the summation of the parameters. Shift4 maybe any right shift or left shift with any integer value such as 0, 1, 3, 4, 6 . . . .
   h. In one example the data may be shifted by Shift5 before/after calculating the determinants (multiplications of final parameters). Shift5 maybe any right shift or left shift with any integer value such as 0, 1, 3, 4, 6, . . . .
   i. In one example the data may be shifted by Shift6 before/after calculating the determinants' division to get final scaled MV adjustment. Shift6 maybe any right shift or left shift with any integer value such as 0, 1, 3, 4, 6, . . . .
   j. In one example the data may be shifted by Shift7 before/after calculating the sample adjustment. Shift7 maybe any right shift or left shift with any integer value such as 0, 1, 3, 4, 6, . . . .
   k. In one example, the shift parameter may be dependent to the bit-depth.

### General Aspects

21. In one example, the division operation disclosed in the document may be replaced by non-division operations, which may share the same or similar logic to the division-replacement logic in CCLM or CCCM.
22. Whether to and/or how to apply the methods described above may be dependent on coded information.
   a. In one example, the coded information may include block sizes and/or temporal layers, and/or slice/picture types, colour component, et al.
23. Whether to and/or how to apply the methods described above may be indicated in the bitstream.
   a. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   b. The indication of enabling/disabling or which method to be applied may be signaled at PB/TB/CB/PU/TU/CU/VPDU/CTU/CTU row/slice/tile/sub-picture/other kinds of region contain more than one sample or pixel.

More details of the embodiments of the present disclosure will be described below which are related to a bi-directional optical flow (BDOF) process. The embodiments of the present disclosure should be considered as examples to explain the general concepts and should not be interpreted in a narrow way. Furthermore, these embodiments can be applied individually or combined in any manner.

As used herein, the term “block” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

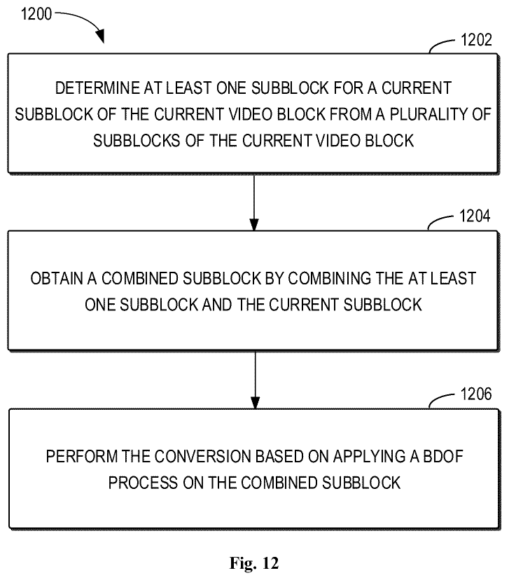

FIG. 12 illustrates a flowchart of a method 1200 for video processing in accordance with some embodiments of the present disclosure. The method 1200 may be implemented during a conversion between a current video block of a video and a bitstream of the video. As shown in FIG. 12, the method 1200 starts at 1202 where at least one subblock is determined for a current subblock of the current video block from a plurality of subblocks of the current video block.

In a first case, a motion vector (MV) of each of the at least one subblock and an MV of the current subblock meet the following condition: the MV of each of the at least one subblock is the same as the MV of the current subblock. In this case, only subblock(s) that has the same MV as the current subblock is selected.

In a second case, the MV of each of the at least one subblock and the MV of the current subblock meet the following condition: a difference metric between the MV of each of the at least one subblock and the MV of the current subblock is smaller than a threshold. In this case, in addition to the subblock(s) that has the same MV as the current subblock, subblock(s) that has a MV similar to the current subblock may also be selected. By way of example rather than limitation, the difference metric may comprise a first order Euclidian distance, a second order Euclidian distance, or the like.

At 1204, a combined subblock is obtained by combining the at least one subblock and the current subblock. For example, the at least one subblock and the current subblock may be merged to obtain a new subblock that has a larger size. Furthermore, the motion information for the combined subblock may be determined based on motion information of the at least one subblock and the current subblock.

For example, in the above-mentioned first case, an MV of the combined subblock may be the same as the MV of the current subblock. In the above-mentioned second case, the MV of the combined subblock may be determined based on MVs of the current subblock and the at least one subblock. In one example embodiment, the MV of the combined subblock may be determined to be an average MV determined by averaging MVs of the current subblock and the at least one subblock. In another example embodiment, the MV of the combined subblock may be determined to be an MV that is the most frequently occurring MV in the MVs of the current subblock and the at least one subblock. In a further example embodiment, the MV of the combined subblock may be determined to be an MV of a subblock that is at a predetermined position. By way of example rather than limitation, the predetermined position may be a center position, a top left position, a bottom right position, and/or the like. It should be understood that the above examples are described merely for purpose of description. The scope of the present disclosure is not limited in this respect.

At 1206, the conversion is performed based on applying a bi-directional optical flow (BDOF) process on the combined subblock. For example, the BDOF process may be performed on the combined subblock to obtain at least one offset. That is, the BDOF process is applied on the at least one subblock and the current subblock as a whole, rather than being performed on each of the at least one subblock and the current subblock. Furthermore, the conversion may be performed based the at least one offset.

In some embodiments, the BDOF process may be a BDOF process for MV refinement. In this process, for example, the at least one offset may be determined for refining the MV of a subblock. Alternatively, the BDOF process may be a BDOF process for sample adjustment, which is also referred to as sampled-based BDOF. In this process, for example, the at least one offset may be determined for adjusting one or more samples in the subblock. It should be noted that the BDOF process may be performed for several rounds. For example, the BDOF process may be performed as one or more rounds of MV refinement process. By way of example rather than limitation, during the MV refinement process, one or more rounds of decoder-side motion vector refinement (DMVR) processes may be performed. Then, the BDOF process for MV refinement may be performed for several rounds. Furthermore, one or more rounds of BDOF process for sample adjustment may be performed. The proposed method may be applied before at least one round of the BDOF process.

In some embodiments, the conversion may include encoding the current video block into the bitstream. Alternatively or additionally, the conversion may include decoding the current video block from the bitstream. It should be understood that the above illustrations are described merely for purpose of description. The scope of the present disclosure is not limited in this respect.

In view of the above, more than one subblocks with the same MV or similar MVs are combined, and the BDOF process is applied on the combined subblock, rather than being applied on each of the more than one subblocks individually. Compared with the conventional solution where the BDOF process is applied on subblocks individually, the proposed method can advantageously perform the BDOF process more efficiently. Thereby, the coding efficiency can be improved.

In some embodiments, the plurality of subblocks may comprise subblocks neighboring to the current subblock. For example, adjacent and non-adjacent subblocks of the current subblock may be check for subblock(s) with the same MV as the current subblock or subblock(s) with an MV similar to the current subblock. In some embodiments, a motion compensation may be applied on the combined subblock. For example, a prediction may be determined for the combined subblock as a whole, based on the motion information determine for the combined subblock.

In some embodiments, the at least one subblock may comprise N neighboring subblocks of the current subblock that are in the same row as the current subblock, and N may be an integer. For example, N1 neighbor subblocks in one row with similar MVs may be merged, N1 may be any integer number such as 2, 3, 4, 10, or the like.

In some embodiments, the at least one subblock may comprise M neighboring subblocks of the current subblock that are in the same column as the current subblock, and M may be an integer. For example, MI neighbor subblocks in one column with similar MVs may be merged. MI may be any integer number such as 2, 3, 4, 10, or the like.

In some embodiments, the at least one subblock may be within sub-prediction unit (PU) boundaries of the i-th round of a decoder-side motion vector refinement (DMVR) process, and i may be an integer, such as 1, 2 or the like. For example, only subblocks within the same sub-PU boundaries are allowed to be combined. These sub-PU boundaries may happen every K pixel, where K may be any integer number such as 8, 16, 19, 32 or the like.

In some embodiments, whether the at least one subblock is in the same row as the current subblock or in the same column as the current subblock may be dependent on a size of the current video block. For example, if a width of the current video block is larger than or equal to a height of the current video block, the at least one subblock may be in the same row as the current subblock. That is, a row-based combination is implemented, i.e., only subblocks in the same row are allowed to be combined. If the width is smaller than the height, the at least one subblock may be in the same column as the current subblock. That is, a column-based combination is implemented, i.e., only subblocks in the same column are allowed to be combined.

Alternatively, if a height of the current video block is larger than a width of the current video block, the at least one subblock may be in the same row as the current subblock. That is, a row-based combination is implemented. If the height is smaller than or equal to the width, the at least one subblock may be in the same column as the current subblock. That is, a column-based combination is implemented.

In some embodiments, the plurality of subblocks is comprised in a subpartition of the current video block that may be of a size larger than each of the plurality of subblocks. For example, for each subblocks inside of a bigger M×N subblock, the MV checking and merging process may be applied. M and N may be any integer such as 4, 5, 10, 16, 32, or the like. This M×N subblock may be regard as a subpartition of the current video block. The size of this subpartition may be variable or fixed. For example, a size of the each of the plurality of subblocks may be 4×4, and the size of the subpartition may be one of 16×16, 8×8, 16×8, or 32×32. Alternatively, the size of the each of the plurality of subblocks may be 8×8, and the size of the subpartition may be one of 16×16, 16×8, or 32×32. It should be understood that the specific values recited herein are intended to be exemplary rather than limiting the scope of the present disclosure.

In some embodiments, the at least one subblock may be allowed to comprise all subblocks of the current video block. For example, all the subblocks inside of a PU or a CU may be allowed to be merged.

In some embodiments, if the difference metric between an MV of a first subblock and the MV of the current subblock is smaller than the threshold and a reference picture for the first subblock may be the same as a reference picture for the current subblock, motion information of at least one of the first subblock or the current subblock may be modified, such that a same motion information may be used for the first subblock and the current subblock in a subsequent process.

In some embodiments, the proposed method may be applied for at least one of two prediction directions. For example, the two prediction directions comprise a prediction direction corresponding to a first reference list (such as list L0 or the like) and a prediction direction corresponding to a second reference list (such as list L1 or the like).

In some embodiments, the BDOF parameters used in the BDOF process may be determined in parallel. For example, a plurality of functions related to the BDOF process may be implemented based on a single instruction multiple data (SIMD) scheme. The SIMD is a parallel processing technique that enables the execution of a single instruction on multiple data elements simultaneously. Thereby, hardware-level parallelism may be leveraged to perform computations on arrays or vectors of data efficiently. By way of example rather than limitation, a plurality of summation operations may be performed at one iteration for determining a sum of BDOF parameters. For example, instead of performing the summation operations in a one-by-one manner, the summation operations may be performed in parallel, such as in a four-by-four manner or the like. It should be understood that any other suitable parallel processing technique may also be implemented.

In some embodiments, a multiplication operation may be implemented with a left shift operation. For example, a multiplication with a weight w may be replaced with a left shift of log 2 (1+w). Thereby, the multiplication operation may be implemented more efficiently.

In some embodiments, one or more parameters used for the BDOF process for MV refinement may be determined based on a condition. For example, if the one or more parameters are to be used, the one or more parameters may be determined. Additionally or alternatively, if a BDOF process for sample adjustment is not applied, the one or more parameters may be determined.

Similarly, one or more parameters used for the BDOF process for sample adjustment may be determined based on a condition. For example, if the one or more parameters are to be used, the one or more parameters may be determined. Additionally or alternatively, if a BDOF process for MV refinement is not applied, the one or more parameters may be determined. Additionally or alternatively, if a result of the BDOF process for MV refinement indicates that MV update is not needed, the one or more parameters may be determined.

Thereby, the parameters used for the BDOF process may be determined only when they are actually needed, and thus the computation resource can be saved and the coding efficiency can be improved.

In some embodiments, a first subblock size used to determine whether a BDOF process for MV refinement is to be applied may be different from a second subblock size used to determine whether a BDOF process for sample adjustment is to be applied. In one example, the second subblock size may be larger than the first subblock size. Alternatively, the second subblock size may be smaller than the first subblock size.

In some embodiments, a shift operation may be performed at one or more stages for determining at least one BDOF parameter used in the BDOF process. In one example, the shift operation may comprise a right shift operation. The right shift operation may be performed, so as to remove noise, avoid overflow, or reduce the bandwidth of the data. In another example, the shift operation may comprise a left shift operation. The left shift operation may be performed to increase accuracy of the derived parameters.

In addition, an offset may be added to an operand of the shift operation, and/or a result of the shift operation. Additionally or alternatively, a result of the shift operation may be clipped to a value range. By way of example, the value range may comprise an upper limit and/or a lower limit, which is predetermined or indicated in the bitstream.

In some embodiments, the shift operation may be performed before any stage of parameter derivation, or during any stage of parameter derivation, or after any stage of parameter derivation. By way of example, the shift operation may be performed on at least one of the following: an input for determining a gradient, an intermediate result for determining the gradient, an output of determining the gradient, an input for determining a difference of luminance, an intermediate result for determining the difference of luminance, an output of determining the difference of luminance, an input for determining a product of gradients, an intermediate result for determining the product of gradients, an output of determining the product of gradients, an input for determining a product of luminance differences, an intermediate result for determining the product of luminance differences, an output of determining the product of luminance differences, an input for determining a summation of parameters, an intermediate result for determining the summation of parameters, an output of determining the summation of parameters, an input for determining a determinant, an intermediate result for determining the determinant, an output of determining the determinant, an input for determining a product of parameters, an intermediate result for determining the product of parameters, an output of determining the product of parameters, an input for determining a product of parameters, an intermediate result for determining the product of parameters, an output of determining the product of parameters, an input for performing a division of determinants, an intermediate result for performing the division of determinants, an output of performing the division of determinants, an input for determining a sample adjustment, an intermediate result for determining the sample adjustment, or an output of determining the sample adjustment. It should be understood that the above examples are described merely for purpose of description. The scope of the present disclosure is not limited in this respect.

In some embodiments, a parameter of the shift operation may be dependent on a bit-depth of the current video block. Alternatively, the parameter of the shift operation may be indicated in the bitstream.

For example, a right shift operation may be implemented, and an offset may be added to a operand of the right shift operation. By way of example, a horizontal gradient and a vertical gradient used for the BDOF process may be determined based on the following:

$$\frac{\partial {I}^{( k )}}{\partial x} ( i , j ) = ( {\sum }_{p = - Nb}^{Na} whp * {I}^{( k )} ( i + p , j ) + A 1 ) ≫ B 1 ,$$

$$\frac{\partial {I}^{( k )}}{\partial y} ( i , j ) = ( {\sum }_{p = - Nb}^{Na} wvp * {I}^{( k )} ( i , j + p ) + A 2 ) ≫ B 2 ,$$

where I^{(k)}(i, j) represents a sample value at coordinate (i, j) of a prediction signal of a reference video block of the combined subblock in a list k, k may be equal to 0 or 1,

$$\frac{\partial {I}^{( k )}}{\partial x} ( i , j )$$

represents a value for the horizontal gradient at coordinate (i, j) of a prediction signal of a reference video block of the combined subblock in a list k,

$$\frac{\partial {I}^{( k )}}{\partial y} ( i , j )$$

represents a value for the vertical gradient at coordinate (i, j) of a prediction signal for a reference video block of the combined subblock in a list k, whp represents a weight for a sample at coordinate (i+p,j), wvp represents a weight for a sample at coordinate (i, j+p), and each of Na, Nb, A1, B1, A2 and B2 represents an integer. By way of example rather than limitation, A1 may be equal to 0 or 1<< (B1-1), and A2 may be equal to 0 or 1<< (B2-1).

In some embodiments, a size of the current subblock may be dependent on the number of samples comprised in the current video block. For example, if the number of samples comprised in the current video block is within a specific value range, the size of the current subblock may be equal to a size corresponding to the specific value range.

Alternatively, the size of the current subblock may be dependent on a width and a height of the current video block. For example, if the width and the height of the current video block is within a specific value range, the size of the current subblock may be equal to a size corresponding to the specific value range.

In some further embodiments, the size of the current subblock may be dependent on a coding tool applied to the current video block. In some still further embodiments, the size of the current subblock may be dependent on a temporal layer of the current video block or a reference video block of the current video block. For example, if the temporal layer is within a specific value range, the size of the current subblock may be equal to a size corresponding to the specific value range.

In some embodiments, a subblock size for a luma block or a chroma block of the current video block may be dependent on at least one of the following: a size of a current prediction unit (PU) comprising the current video block, a size of a current coding unit (CU) comprising the current video block, a characteristic of a plurality of reference video blocks of the current video block, a similarity of a plurality of predictors from the plurality of reference video blocks, a distribution of difference between a plurality of predictors from the plurality of reference video blocks, a temporal gradient of the plurality of reference video blocks, a spatial gradient of the plurality of reference video blocks, a prediction type, an adjustment value determined in a first pass of a multi-pass decoder side motion vector refinement (DMVR), an adjustment value determined in a second pass of the multi-pass DMVR, a sequence resolution, a color component of the current video block, a color format of the current video block, coded information of the current video block, information of at least one prediction block of the current video block, or a value of a quantization parameter (QP) associated with the current video block. It should be understood that the above examples are described merely for purpose of description. The scope of the present disclosure is not limited in this respect.

In one example embodiment, the coded information may comprise residual information, a coding tool applied to the current video block, and/or the like. Additionally or alternatively, the at least one prediction block may comprise a plurality of prediction blocks from a plurality of reference picture lists (such as, list0, list1, and/or the like) of the current video block. In addition, the information of at least one prediction block may comprise characteristics of the at least one prediction block, size of the at least one prediction block, and/or the like. Furthermore, the quantization parameter associated with the current video block may comprise a quantization parameter of the current video block, a quantization parameter of a current coding unit (CU) comprising the current video block, a quantization parameter of a current slice comprising the current video block, a quantization parameter of a sequence comprising the current video block, or the like.

In some embodiments, a subblock size for a chroma block of the current video block may be determined based on a subblock size for a luma block of the current video block and at least one of the following: a color format of the current video block, or information regarding whether separate plane coding enabled for the current video block.

In some embodiments, a BDOF process for MV refinement and a BDOF process for sample adjustment may be controlled separately. For example, the BDOF process for MV refinement may be applied, while the BDOF process for sample adjustment is not applied. Alternatively, the BDOF process for sample adjustment may be applied, while the BDOF process for MV refinement is not applied. For example, the controlling may be performed at a sub-PU level, a coding unit (CU) level, a coding tree unit (CTU) level, and/or the like.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, at least one subblock is determined for a current subblock of a current video block of the video from a plurality of subblocks of the current video block. A motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold. Furthermore, a combined subblock is obtained by combining the at least one subblock and the current subblock. The bitstream is generated based on applying a bi-directional optical flow (BDOF) process on the combined subblock.

According to still further embodiments of the present disclosure, a method for storing bitstream of a video is provided. In the method, at least one subblock is determined for a current subblock of a current video block of the video from a plurality of subblocks of the current video block. A motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold. Furthermore, a combined subblock is obtained by combining the at least one subblock and the current subblock. The bitstream is generated based on applying a bi-directional optical flow (BDOF) process on the combined subblock, and stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, at least one subblock for a current subblock of the current video block from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock by combining the at least one subblock and the current subblock; and performing the conversion based on applying a bi-directional optical flow (BDOF) process on the combined subblock.

Clause 2. The method of clause 1, wherein the difference metric comprises a first order Euclidian distance or a second order Euclidian distance.

Clause 3. The method of any of clauses 1-2, wherein if the MV of each of the at least one subblock is the same as the MV of the current subblock, an MV of the combined subblock is the same as the MV of the current subblock, or if the difference metric is smaller than the threshold, the MV of the combined subblock is determined based on MVs of the current subblock and the at least one subblock.

Clause 4. The method of any of clauses 1-3, wherein if the difference metric is smaller than the threshold, the MV of the combined subblock is determined to be one of the following: an average MV determined by averaging MVs of the current subblock and the at least one subblock, an MV that is the most frequently occurring MV in the MVs of the current subblock and the at least one subblock, or an MV of a subblock that is at a predetermined position.

Clause 5. The method of clause 4, wherein the predetermined position comprises one of the following: a center position, a top left position, or a bottom right position.

Clause 6. The method of any of clauses 1-5, wherein the BDOF process is a BDOF process for MV refinement or a BDOF process for sample adjustment.

Clause 7. The method of clause 6, wherein the BDOF process is one round of a MV refinement process.

Clause 8. The method of any of clauses 1-7, wherein the plurality of subblocks comprises subblocks neighboring to the current subblock.

Clause 9. The method of any of clauses 1-8, wherein a motion compensation is applied on the combined subblock.

Clause 10. The method of any of clauses 1-9, wherein the at least one subblock comprise N neighboring subblocks of the current subblock that are in the same row as the current subblock, and N is an integer.

Clause 11. The method of any of clauses 1-10, wherein the at least one subblock comprise M neighboring subblocks of the current subblock that are in the same column as the current subblock, and M is an integer.

Clause 12. The method of any of clauses 10-11, wherein the at least one subblock is within sub-prediction unit (PU) boundaries of the i-th round of a decoder-side motion vector refinement (DMVR) process, and i is an integer.

Clause 13. The method of any of clauses 1-12, wherein whether the at least one subblock is in the same row as the current subblock or in the same column as the current subblock is dependent on a size of the current video block.

Clause 14. The method of clause 13, wherein if a width of the current video block is larger than or equal to a height of the current video block, the at least one subblock is in the same row as the current subblock, or if the width is smaller than the height, the at least one subblock is in the same column as the current subblock.

Clause 15. The method of clause 13, wherein if a height of the current video block is larger than a width of the current video block, the at least one subblock is in the same row as the current subblock, or if the height is smaller than or equal to the width, the at least one subblock is in the same column as the current subblock.

Clause 16. The method of any of clauses 1-15, wherein the plurality of subblocks are comprised in a subpartition of the current video block that is of a size larger than each of the plurality of subblocks.

Clause 17. The method of clause 16, wherein a size of the each of the plurality of subblocks is 4×4, and the size of the subpartition is one of 16×16, 8×8, 16×8, or 32×32, or the size of the each of the plurality of subblocks is 8×8, and the size of the subpartition is one of 16×16, 16×8, or 32×32.

Clause 18. The method of any of clauses 16-17, wherein the size of the subpartition is variable or fixed.

Clause 19. The method of any of clauses 1-18, wherein the at least one subblock is allowed to comprise all subblocks of the current video block.

Clause 20. The method of any of clauses 1-19, wherein if the difference metric between an MV of a first subblock and the MV of the current subblock is smaller than the threshold and a reference picture for the first subblock is the same as a reference picture for the current subblock, motion information of at least one of the first subblock or the current subblock is modified, such that a same motion information is used for the first subblock and the current subblock in a subsequent process.

Clause 21. The method of any of clauses 1-20, wherein the method is applied for at least one of two prediction directions.

Clause 22. The method of clause 21, wherein the two prediction directions comprise a prediction direction corresponding to a first reference list and a prediction direction corresponding to a second reference list.

Clause 23. The method of any of clauses 1-22, wherein BDOF parameters used in the BDOF process are determined in parallel.

Clause 24. The method of any of clauses 1-23, wherein a plurality of functions related to the BDOF process are implemented based on a single instruction multiple data (SIMD) scheme.

Clause 25. The method of any of clauses 1-24, wherein a plurality of summation operations are performed at one iteration for determining a sum of BDOF parameters.

Clause 26. The method of any of clauses 1-25, wherein a multiplication operation is implemented with a left shift operation.

Clause 27. The method of clause 26, wherein a multiplication with a weight w is replaced with a left shift of log 2 (1+w).

Clause 28. The method of any of clauses 1-27, wherein one or more parameters used for the BDOF process for MV refinement are determined based on a condition.

Clause 29. The method of clause 28, wherein if the one or more parameters are to be used, the one or more parameters are determined, or if a BDOF process for sample adjustment is not applied, the one or more parameters are determined.

Clause 30. The method of any of clauses 1-29, wherein one or more parameters used for the BDOF process for sample adjustment are determined based on a condition.

Clause 31. The method of clause 30, wherein if the one or more parameters are to be used, the one or more parameters are determined, or if a BDOF process for MV refinement is not applied, the one or more parameters are determined, or if a result of the BDOF process for MV refinement indicates that MV update is not needed, the one or more parameters are determined.

Clause 32. The method of any of clauses 1-31, wherein a first subblock size used to determine whether a BDOF process for MV refinement is to be applied is different from a second subblock size used to determine whether a BDOF process for sample adjustment is to be applied.

Clause 33. The method of clause 32, wherein the second subblock size is larger than the first subblock size, or the second subblock size is smaller than the first subblock size.

Clause 34. The method of any of clauses 1-33, wherein a shift operation is performed at one or more stages for determining at least one BDOF parameter used in the BDOF process.

Clause 35. The method of clause 34, wherein the shift operation comprises a right shift operation or a left shift operation.

Clause 36. The method of any of clauses 34-35, wherein an offset is added to at least one of the following: an operand of the shift operation, or a result of the shift operation.

Clause 37. The method of any of clauses 34-36, wherein a result of the shift operation is clipped to a value range.

Clause 38. The method of any of clauses 34-37, wherein the shift operation is performed on at least one of the following: an input for determining a gradient, an intermediate result for determining the gradient, an output of determining the gradient, an input for determining a difference of luminance, an intermediate result for determining the difference of luminance, an output of determining the difference of luminance, an input for determining a product of gradients, an intermediate result for determining the product of gradients, an output of determining the product of gradients, an input for determining a product of luminance differences, an intermediate result for determining the product of luminance differences, an output of determining the product of luminance differences, an input for determining a summation of parameters, an intermediate result for determining the summation of parameters, an output of determining the summation of parameters, an input for determining a determinant, an intermediate result for determining the determinant, an output of determining the determinant, an input for determining a product of parameters, an intermediate result for determining the product of parameters, an output of determining the product of parameters, an input for determining a product of parameters, an intermediate result for determining the product of parameters, an output of determining the product of parameters, an input for performing a division of determinants, an intermediate result for performing the division of determinants, an output of performing the division of determinants, an input for determining a sample adjustment, an intermediate result for determining the sample adjustment, or an output of determining the sample adjustment.

Clause 39. The method of any of clauses 34-38, wherein a parameter of the shift operation is dependent on a bit-depth of the current video block.

Clause 40. The method of any of clauses 1-39, wherein a horizontal gradient and a vertical gradient used for the BDOF process are determined based on the following:

$$\frac{\partial {I}^{( k )}}{\partial x} ( i , j ) = ( {\sum }_{p = - Nb}^{Na} whp * {I}^{( k )} ( i + p , j ) + A 1 ) ≫ B 1 ,$$

$$\frac{\partial {I}^{( k )}}{\partial y} ( i , j ) = ( {\sum }_{p = - Nb}^{Na} wvp * {I}^{( k )} ( i , j + p ) + A 2 ) ≫ B 2 ,$$

wherein I^{(k)}(i, j) represents a sample value at coordinate (i,j) of a prediction signal of a reference video block of the combined subblock in a list k, k is equal to 0 or 1,

$$\frac{\partial {I}^{( k )}}{\partial x} ( i , j )$$

represents a value for the horizontal gradient at coordinate (i, j) of a prediction signal of a reference video block of the combined subblock in a list k.

$$\frac{\partial {I}^{( k )}}{\partial y} ( i , j )$$

represents a value for the vertical gradient at coordinate (i, j) of a prediction signal for a reference video block of the combined subblock in a list k, whp represents a weight for a sample at coordinate (i+p,j), wvp represents a weight for a sample at coordinate (i, j+p), and each of Na, Nb, A1, B1, A2 and B2 represents an integer.

Clause 41. The method of clause 40, wherein A1 is equal to 0 or 1<< (B1-1), and A2 is equal to 0 or 1<< (B2-1).

Clause 42. The method of any of clauses 1-41, wherein a size of the current subblock is dependent on the number of samples comprised in the current video block.

Clause 43. The method of clause 42, wherein if the number of samples comprised in the current video block is within a value range, the size of the current subblock is equal to a size corresponding to the value range.

Clause 44. The method of any of clauses 1-41, wherein a size of the current subblock is dependent on a width and a height of the current video block.

Clause 45. The method of clause 44, wherein if the width and the height of the current video block are within a value range, the size of the current subblock is equal to a size corresponding to the value range.

Clause 46. The method of any of clauses 1-45, wherein a size of the current subblock is dependent on a coding tool applied to the current video block.

Clause 47. The method of any of clauses 1-46, wherein a size of the current subblock is dependent on a temporal layer of the current video block or a reference video block of the current video block.

Clause 48. The method of clause 47, wherein if the temporal layer is within a value range, the size of the current subblock is equal to a size corresponding to the value range.

Clause 49. The method of any of clauses 1-48, wherein a subblock size for a luma block or a chroma block of the current video block is dependent on at least one of the following: a size of a current prediction unit (PU) comprising the current video block, a size of a current coding unit (CU) comprising the current video block, a characteristic of a plurality of reference video blocks of the current video block, a similarity of a plurality of predictors from the plurality of reference video blocks, a distribution of difference between a plurality of predictors from the plurality of reference video blocks, a temporal gradient of the plurality of reference video blocks, a spatial gradient of the plurality of reference video blocks, a prediction type, an adjustment value determined in a first pass of a multi-pass decoder side motion vector refinement (DMVR), an adjustment value determined in a second pass of the multi-pass DMVR, a sequence resolution, a color component of the current video block, a color format of the current video block, coded information of the current video block, information of at least one prediction block of the current video block, or a value of a quantization parameter (QP) associated with the current video block.

Clause 50. The method of any of clauses 1-48, wherein a subblock size for a chroma block of the current video block is determined based on a subblock size for a luma block of the current video block and at least one of the following: a color format of the current video block, or information regarding whether separate plane coding enabled for the current video block.

Clause 51. The method of any of clauses 1-50, wherein a BDOF process for MV refinement and a BDOF process for sample adjustment are controlled separately.

Clause 52. The method of clause 51, wherein the BDOF process for MV refinement is applied and the BDOF process for sample adjustment is not applied.

Clause 53. The method of any of clauses 51-52, wherein the controlling is performed at one of the following: a sub-PU level, a coding unit (CU) level, or a coding tree unit (CTU) level.

Clause 54. The method of any of clauses 1-53, wherein the conversion includes encoding the current video block into the bitstream.

Clause 55. The method of any of clauses 1-53, wherein the conversion includes decoding the current video block from the bitstream.

Clause 56. An apparatus for video processing comprising a processor and a non-transitory memory with instructions thereon, wherein the instructions upon execution by the processor, cause the processor to perform a method in accordance with any of clauses 1-55.

Clause 57. A non-transitory computer-readable storage medium storing instructions that cause a processor to perform a method in accordance with any of clauses 1-55.

Clause 58. A non-transitory computer-readable recording medium storing a bitstream of a video which is generated by a method performed by an apparatus for video processing, wherein the method comprises: determining at least one subblock for a current subblock of a current video block of the video from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock by combining the at least one subblock and the current subblock; and generating the bitstream based on applying a bi-directional optical flow (BDOF) process on the combined subblock.

Clause 59. A method for storing a bitstream of a video, comprising: determining at least one subblock for a current subblock of a current video block of the video from a plurality of subblocks of the current video block, a motion vector (MV) of each of the at least one subblock and an MV of the current subblock meet one of the following conditions: the MV of each of the at least one subblock is the same as the MV of the current subblock, or a difference metric between the MV of each of the at least one subblock and the MV of the current subblock is smaller than a threshold; obtaining a combined subblock by combining the at least one subblock and the current subblock; and generating the bitstream based on applying a bi-directional optical flow (BDOF) process on the combined subblock; and storing the bitstream in a non-transitory computer-readable recording medium.

### Example Device

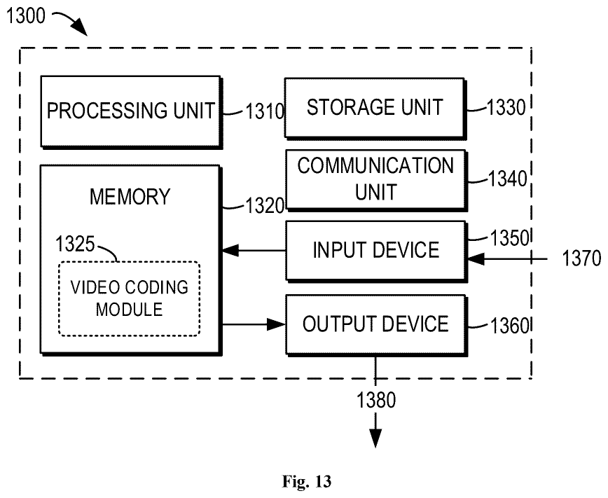

FIG. 13 illustrates a block diagram of a computing device 1300 in which various embodiments of the present disclosure can be implemented. The computing device 1300 may be implemented as or included in the source device 110 (or the video encoder 114 or 200) or the destination device 120 (or the video decoder 124 or 300).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement video encoding/decoding in embodiments of the present disclosure. The memory 1320 may include one or more video coding modules 1325 having one or more program instructions. These modules are accessible and executable by the processing unit 1310 to perform the functionalities of the various embodiments described herein.

In the example embodiments of performing video encoding, the input device 1350 may receive video data as an input 1370 to be encoded. The video data may be processed, for example, by the video coding module 1325, to generate an encoded bitstream. The encoded bitstream may be provided via the output device 1360 as an output 1380.

In the example embodiments of performing video decoding, the input device 1350 may receive an encoded bitstream as the input 1370. The encoded bitstream may be processed, for example, by the video coding module 1325, to generate decoded video data. The decoded video data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended 5 to be limiting.

1. A method for video processing, comprising:
determining, during a conversion between a current block of a video and a bitstream of the video, reference samples of a sub-template of the current block based on a first set of reference samples of the sub-template in a first reference list and a second set of reference samples of the sub-template in a second reference list; and
determining a target motion candidate list based on the reference samples of the sub-template.

2. The method of claim 1, wherein determining the reference samples of the sub-template comprises:
determining a weighted average of the first set of reference samples and the second set of reference samples, wherein the first set of reference samples are associated with a first weight, and the second set of reference samples are associated with a second weight; and
determining the reference sample of the template based on the weighted average.

3. The method of claim 2, wherein the first weight is equal to the second weight.

4. The method of claim 3, wherein the reference samples of the sub-template (RT) are determined according to:
$$RT ( x , y ) = ( {RT}_{0} ( x , y ) + {RT}_{1} ( x , y ) + 1 ) ≫ 1$$
wherein RT₀ denotes the first set of reference samples and RT₁ denotes the second set of reference samples.

5. The method of claim 2, wherein the reference samples of the sub-template (RT) are determined according to:
$$RT ( x , y ) = ( ( {2}^{N} - w ) * {RT}_{0} ( x , y ) + w * {RT}_{1} ( x , y ) + {2}^{N - 1} ) ≫ N$$
wherein RT₀ denotes the first set of reference samples, RT₁ denotes the second set of reference samples, and N is a positive integer.

6. The method of claim 5, wherein wis determined according to at least one of the following rules:
if a CU-level weight (BCW) index is equal to 0, wis set equal to −2;
if the BCW index is equal to 1, wis set equal to 3;
if the BCW index is equal to 2, wis set equal to 4;
if the BCW index is equal to 3, wis set equal to 5; or
if the BCW index is equal to 4, wis set equal to 10.

7. The method of claim 2, wherein at least one of the first weight and the second weight is determined based on a BCW index.

8. The method of claim 2, wherein at least one of the first weight and the second weight is predefined.

9. The method of claim 2, wherein at least one of the first weight and the second weight is comprised in the bitstream.

10. The method of claim 2, wherein at least one of the first weight and the second weight is determined based on a weight used in weighted prediction.

11. The method of claim 1, wherein the reference samples of the sub-template are derived with a multi-hypothesis prediction method if a corresponding merge candidate uses multi-hypothesis prediction.

12. The method of claim 1, wherein determining the target motion candidate list comprises:
constructing a first motion candidate list for the current block;
determining a reordering scheme; and
determining the target motion candidate list based on the reordering scheme and the reference samples.

13. The method of claim 12, wherein determining the reordering scheme comprises:
determining a reordering scheme to indicate that the first motion candidate list or at least one motion candidate in the first motion candidate list is to be reordered, in accordance with a determination that the at least one motion candidate belongs to at least one of the following categories:
a category of adjacent spatial motion candidates,
a category of temporal motion candidates,
a category of spatial temporal motion vector prediction (STMVP) motion candidates,
a category of non-adjacent spatial motion candidates,
a category of history-based motion vector prediction (HMVP) motion candidates, or
a category of pair-wise average motion candidates.

14. The method of claim 12, wherein determining a reordering scheme comprises:
determining a reordering scheme to indicate that at least one zero motion candidate is not to be reordered.

15. The method of claim 12, wherein determining a reordering scheme comprises:
determining a reordering scheme to indicate that at least one motion candidate in the first motion candidate list is not to be reordered in accordance with a determination that the at least one motion candidate belongs to at least one of the following categories:
a category of uni-prediction subblock based motion candidates,
a category of subblock-based temporal motion vector prediction (SbTMVP) motion candidates,
a category of inherited affine motion candidates,
a category of constructed affine motion candidates, or
a category of zero padding affine motion candidates.

16. The method of claim 12, wherein determining a reordering scheme comprises:
determining the reordering scheme to indicate that a number of motion candidates from a beginning of the first motion candidate list are to be reordered.

17. The method of claim 12, wherein the first motion candidate list is divided into at least one subgroup of motion candidates, and wherein determining a reordering scheme comprises:
determining the reordering scheme based on the at least one subgroup of motion candidates.

18. The method of claim 17, wherein the reordering scheme indicates at least one of the following:
only the first subgroup of motion candidates is to be reordered,
a last subgroup of motion candidates is not to be reordered,
the last subgroup of motion candidates is to be reordered if the last subgroup is also the first group,
different subgroups are to be reordered separately,
two motion candidates in different subgroups are not to be reordered together, or
a first motion candidate in a first subgroup is to be put ahead of a second motion candidate in a second subgroup after reordering if the first subgroup is ahead of the second subgroup.

19. The method of claim 1, wherein determining the first motion candidate list comprises:
in accordance with a determination that the reordering scheme indicates that at least one first motion candidate in the first motion candidate list is not to be reordered,
determining an order of the first at least one motion candidate within the target motion candidate list according to an original order of the at least one first motion candidate within the first motion candidate list.

20. The method of claim 1, wherein determining the first motion candidate list comprises:
in accordance with a determination that the reordering scheme indicates that at least one first motion candidate in the first motion candidate list is not to be reordered and at least one second motion candidate in the first motion candidate list is to be reordered,
arranging, within the target motion candidate list, the at least one first motion candidate to be ahead of the at least one second motion candidate to be reordered, or
arranging, within the target motion candidate list, the at least one first motion candidate to follow the at least one second motion candidate to be reordered.

21. The method of claim 1, wherein the bitstream comprises a signal indicating the reordering scheme applied on the first motion candidate list.

22. The method of claim 1, wherein the sub-template comprises samples of at least one color component.

23. The method of claim 22, wherein the sub-template only comprises samples of the luma component.

24. The method of claim 22, wherein the sub-template comprises samples of the at least one of:
a Cb component, a Cr component, a R component, a G component or a B component.

25. The method of any of claims 1-24, wherein the conversion comprises decoding the current block from the bitstream.

26. The method of any of claims 1-24, wherein the conversion comprises encoding the current block into the bitstream.

27. A method for video processing, comprising:
determining, during a conversion between a current block of a video and a bitstream of the video, reference samples of a template or a sub-template of the current block using a Local illumination compensation (LIC) method, wherein a first set of LIC parameters of the template of the sub-templates are determined based on a second set of LIC parameters of the current block; and
determining a target motion candidate list based on the reference samples.

28. The method of claim 27, wherein the first set of LIC parameters for both left and above templates or sub-templates are the same as the second set of LIC parameters of the current block.

29. The method of claim 27, wherein the first set of LIC parameters for a left template or sub-template are derived as the second set of LIC parameters of the current block.

30. The method of claim 27, wherein the first set of LIC parameters for a above template or sub-template are derived as the second set of LIC parameters of the current block.

31. The method of claim 27, wherein the LIC method is applied when a LIC flag of a corresponding candidate is true.

32. The method of claim 27, wherein the reference samples of the template or sub-template are derived with a multi-hypothesis prediction method if a corresponding merge candidate uses multi-hypothesis prediction.

33. The method of claim 27, wherein determining the target motion candidate list comprises:
constructing a first motion candidate list for the current block;
determining a reordering scheme; and
determining the target motion candidate list based on the reordering scheme and the reference samples.

34. The method of claim 33, wherein determining the reordering scheme comprises:
determining a reordering scheme to indicate that the first motion candidate list or at least one motion candidate in the first motion candidate list is to be reordered, in accordance with a determination that the at least one motion candidate belongs to at least one of the following categories:
a category of adjacent spatial motion candidates,
a category of temporal motion candidates,
a category of spatial temporal motion vector prediction (STMVP) motion candidates,
a category of non-adjacent spatial motion candidates,
a category of history-based motion vector prediction (HMVP) motion candidates, or
a category of pair-wise average motion candidates.

35. The method of claim 33, wherein determining a reordering scheme comprises:
determining a reordering scheme to indicate that at least one zero motion candidate is not to be reordered.

36. The method of claim 33, wherein determining a reordering scheme comprises:
determining a reordering scheme to indicate that at least one motion candidate in the first motion candidate list is not to be reordered in accordance with a determination that the at least one motion candidate belongs to at least one of the following categories:
a category of uni-prediction subblock based motion candidates,
a category of subblock-based temporal motion vector prediction (SbTMVP) motion candidates,
a category of inherited affine motion candidates,
a category of constructed affine motion candidates, or
a category of zero padding affine motion candidates.

37. The method of claim 33, wherein determining a reordering scheme comprises:
determining the reordering scheme to indicate that a number of motion candidates from a beginning of the first motion candidate list are to be reordered.

38. The method of claim 33, wherein the first motion candidate list is divided into at least one subgroup of motion candidates, and wherein determining a reordering scheme comprises:
determining the reordering scheme based on the at least one subgroup of motion candidates.

39. The method of claim 38, wherein the reordering scheme indicates at least one of the following:
only the first subgroup of motion candidates is to be reordered,
a last subgroup of motion candidates is not to be reordered,
the last subgroup of motion candidates is to be reordered if the last subgroup is also the first group,
different subgroups are to be reordered separately,
two motion candidates in different subgroups are not to be reordered together, or
a first motion candidate in a first subgroup is to be put ahead of a second motion candidate in a second subgroup after reordering if the first subgroup is ahead of the second subgroup.

40. The method of claim 27, wherein determining the first motion candidate list comprises:
in accordance with a determination that the reordering scheme indicates that at least one first motion candidate in the first motion candidate list is not to be reordered,
determining an order of the first at least one motion candidate within the target motion candidate list according to an original order of the at least one first motion candidate within the first motion candidate list.

41. The method of claim 27, wherein determining the first motion candidate list comprises:
in accordance with a determination that the reordering scheme indicates that at least one first motion candidate in the first motion candidate list is not to be reordered and at least one second motion candidate in the first motion candidate list is to be reordered,
arranging, within the target motion candidate list, the at least one first motion candidate to be ahead of the at least one second motion candidate to be reordered, or
arranging, within the target motion candidate list, the at least one first motion candidate to follow the at least one second motion candidate to be reordered.

42. The method of claim 27, wherein the bitstream comprises a signal indicating the reordering scheme applied on the first motion candidate list.

43. The method of claim 27, wherein the template or sub-template comprises samples of at least one color component.

44. The method of claim 43, wherein the template or sub-template only comprises samples of the luma component.

45. The method of claim 43, wherein the template or sub-template comprises samples of the at least one of:
a Cb component, a Cr component, a R component, a G component, or a B component.

46. The method of any of claims 27-45, wherein the conversion comprises decoding the current block from the bitstream.

47. The method of any of claims 27-45, wherein the conversion comprises encoding the current block into the bitstream.

48. A method for video processing, comprising:
determining, during a conversion between a current block of a video and a bitstream of the video, reference samples of a template or sub-template of the current block according to an Overlapped Block Motion Compensation (OBMC) method; and
determining a target motion candidate list based on the reference samples of the template or sub-template.

49. The method of claim 48, wherein determining the reference samples of the template or sub-template of the current block comprises:
determining the reference samples of a above template or sub-template based on motion information of a first set of subblocks in a first row of the current block and a second set of above adjacent neighboring subblocks of the first set of subblocks.

50. The method of claim 48, wherein determining the reference samples of the template or sub-template of the current block comprises:
determining the reference samples of a left template or sub-template based on motion information of a third set of subblocks in a first column of the current block and a fourth set of left adjacent neighboring subblocks of the third set of subblocks.

51. The method of claim 49 or 50, wherein a size of a subblock is 4×4.

52. The method of claim 48, wherein determining the reference samples of the sub-template of the current block comprises:
determining the reference samples based on a first set of reference samples P_{N} and a second set of reference samples P_{C} of the sub-template, wherein the first set of reference samples P_{N} are determined based on motion vectors of a neighbouring subblock, and the second set of reference samples P_{C} are determined based on motion vectors of a subblock of current block.

53. The method of claim 52, wherein the first set of reference samples P_{N} are generated based on motion vectors of vertically neighbouring sub-block, and the samples in the same row of P_{N} are added to P_{C} with a same weighting factor.

54. The method of claim 53, wherein if a height of the above template is larger than or equal to 4:
a weighting factor ¼ is applied to a first row of P_{N}, a weighting factor ⅛ is applied to a second row of P_{N}, a weighting factor 1/16 is applied to a third row of P_{N}, and a weighting factor 1/32 is applied to a fourth row of P_{N}; and/or
a weighting factor ¾ is applied to a first row of P_{C}, a weighting factor ⅞ is applied to a second row of P_{C}, a weighting factor 15/16 is applied to a third row of P_{C}, and a weighting factor 31/32 is applied to a fourth row of P_{C}.

55. The method of claim 53, wherein if a height of a above template is larger than or equal to 2:
a weighting factor ¼ is applied to a first row of P_{N}, a weighting factor ⅛ is applied to a second row of P_{N}; and/or
a weighting factor ¾ is applied to a first row of P_{C}, a weighting factor ⅞ is applied to a second row of P_{C}.

56. The method of claim 53, wherein if a height of a above template is larger than or equal to 1:
a weighting factor ¼ is applied to a first row of P_{N}; and/or
a weighting factor ¾ is applied to a first row of P_{C}.

57. The method of claim 52, wherein the first set of reference samples P_{N} are generated based on motion vectors of horizontally neighbouring sub-block, and the samples in the same column of P_{N} are added to P_{C} with a same weighting factor.

58. The method of claim 57, wherein if a width of the left template is larger than or equal to 4:
a weighting factor ¼ is applied to a first column of P_{N}, a weighting factor ⅛ is applied to a second column of P_{N}, a weighting factor 1/16 is applied to a third column of P_{N}, and a weighting factor 1/32 is applied to a fourth column of P_{N}; and/or
a weighting factor ¾ is applied to a first column of P_{C}, a weighting factor ⅞ is applied to a second column of P_{C}, a weighting factor 15/16 is applied to a third column of P_{C}, and a weighting factor 31/32 is applied to a fourth column of P_{C}.

59. The method of claim 57, wherein if a width of the left template is larger than or equal to 2:
a weighting factor ¼ is applied to a first column of P_{N}, a weighting factor ⅛ is applied to a second column of P_{N}; and/or
a weighting factor ¾ is applied to a first column of P_{C}, a weighting factor ⅞ is applied to a second column of P_{C}.

60. The method of claim 57, wherein if a width of the left template is larger than or equal to 1:
a weighting factor ¼ is applied to a first column of P_{N}; and/or
a weighting factor ¾ is applied to a first column of P_{C}.

61. The method of claim 53, wherein the reference samples of the sub-template (P) are determined according to:
$$P = {W}_{N} * {P}_{N} + {W}_{C} * {P}_{C}$$
wherein W_{N} and We are weighting factors.

62. The method of claim 53, wherein the OBMC method is enabled if a corresponding merge candidate is assigned with OBMC enabled.

63. The method of claim 48, wherein the reference samples of the template or sub-template are derived with a multi-hypothesis prediction method if a corresponding merge candidate uses multi-hypothesis prediction.

64. The method of claim 48, wherein determining the target motion candidate list comprises:
constructing a first motion candidate list for the current block;
determining a reordering scheme; and
determining the target motion candidate list based on the reordering scheme and the reference samples.

65. The method of claim 64, wherein determining the reordering scheme comprises:
determining a reordering scheme to indicate that the first motion candidate list or at least one motion candidate in the first motion candidate list is to be reordered, in accordance with a determination that the at least one motion candidate belongs to at least one of the following categories:
a category of adjacent spatial motion candidates,
a category of temporal motion candidates,
a category of spatial temporal motion vector prediction (STMVP) motion candidates,
a category of non-adjacent spatial motion candidates,
a category of history-based motion vector prediction (HMVP) motion candidates, or
a category of pair-wise average motion candidates.

66. The method of claim 64, wherein determining a reordering scheme comprises:
determining a reordering scheme to indicate that at least one zero motion candidate is not to be reordered.

67. The method of claim 64, wherein determining a reordering scheme comprises:
determining a reordering scheme to indicate that at least one motion candidate in the first motion candidate list is not to be reordered in accordance with a determination that the at least one motion candidate belongs to at least one of the following categories:
a category of uni-prediction subblock based motion candidates,
a category of subblock-based temporal motion vector prediction (SbTMVP) motion candidates,
a category of inherited affine motion candidates,
a category of constructed affine motion candidates, or
a category of zero padding affine motion candidates.

68. The method of claim 64, wherein determining a reordering scheme comprises:
determining the reordering scheme to indicate that a number of motion candidates from a beginning of the first motion candidate list are to be reordered.

69. The method of claim 64, wherein the first motion candidate list is divided into at least one subgroup of motion candidates, and wherein determining a reordering scheme comprises:
determining the reordering scheme based on the at least one subgroup of motion candidates.

70. The method of claim 69, wherein the reordering scheme indicates at least one of the following:
only the first subgroup of motion candidates is to be reordered,
a last subgroup of motion candidates is not to be reordered,
the last subgroup of motion candidates is to be reordered if the last subgroup is also the first group,
different subgroups are to be reordered separately,
two motion candidates in different subgroups are not to be reordered together, or
a first motion candidate in a first subgroup is to be put ahead of a second motion candidate in a second subgroup after reordering if the first subgroup is ahead of the second subgroup.

71. The method of claim 48, wherein determining the first motion candidate list comprises:
in accordance with a determination that the reordering scheme indicates that at least one first motion candidate in the first motion candidate list is not to be reordered,
determining an order of the first at least one motion candidate within the target motion candidate list according to an original order of the at least one first motion candidate within the first motion candidate list.

72. The method of claim 48, wherein determining the first motion candidate list comprises:
in accordance with a determination that the reordering scheme indicates that at least one first motion candidate in the first motion candidate list is not to be reordered and at least one second motion candidate in the first motion candidate list is to be reordered,
arranging, within the target motion candidate list, the at least one first motion candidate to be ahead of the at least one second motion candidate to be reordered, or
arranging, within the target motion candidate list, the at least one first motion candidate to follow the at least one second motion candidate to be reordered.

73. The method of claim 48, wherein the bitstream comprises a signal indicating the reordering scheme applied on the first motion candidate list.

74. The method of claim 48, wherein the template or sub-template comprises samples of at least one color component.

75. The method of claim 74, wherein the template or sub-template only comprises samples of the luma component.

76. The method of claim 74, wherein the template or sub-template comprises samples of the at least one of:
a Cb component, a Cr component, a R component, a G component, or a B component.

77. The method of any of claims 48-76, wherein the conversion comprises decoding the current block from the bitstream.

78. The method of any of claims 48-76, wherein the conversion comprises encoding the current block into the bitstream.

79. An apparatus for processing video data comprising a processor and a non-transitory memory with instructions thereon, wherein the instructions upon execution by the processor, cause the processor to:
determine, during a conversion between a current block of a video and a bitstream of the video, reference samples of a sub-template of the current block based on a first set of reference samples of the sub-template in a first reference list and a second set of reference samples of the sub-template in a second reference list; and
determine a target motion candidate list based on the reference samples of the sub-template.

80. A non-transitory computer-readable storage medium storing instructions that cause a processor to:
determining, during a conversion between a current block of a video and a bitstream of the video, reference samples of a sub-template of the current block based on a first set of reference samples of the sub-template in a first reference list and a second set of reference samples of the sub-template in a second reference list; and
determining a target motion candidate list based on the reference samples of the sub-template.

81. A non-transitory computer-readable recording medium storing a bitstream of a video which is generated by a method performed by a video processing apparatus, wherein the method comprises:
determining, during a conversion between a current block of a video and a bitstream of the video, reference samples of a sub-template of the current block based on a first set of reference samples of the sub-template in a first reference list and a second set of reference samples of the sub-template in a second reference list;
determining a target motion candidate list based on the reference samples of the sub-template; and
generating the bitstream based on the target motion candidate list.

82. A method for storing bitstream of a video, comprising:
determining, during a conversion between a current block of a video and a bitstream of the video, reference samples of a sub-template of the current block based on a first set of reference samples of the sub-template in a first reference list and a second set of reference samples of the sub-template in a second reference list;
determining a target motion candidate list based on the reference samples of the sub-template;
generating the bitstream based on the target motion candidate list; and
storing the bitstream in a non-transitory computer-readable recording medium.

83. An apparatus for processing video data comprising a processor and a non-transitory memory with instructions thereon, wherein the instructions upon execution by the processor, cause the processor to:
determine, during a conversion between a current block of a video and a bitstream of the video, reference samples of a template or a sub-template of the current block using a Local illumination compensation (LIC) method, wherein a first set of LIC parameters of the template of the sub-templates are determined based on a second set of LIC parameters of the current block; and
determine a target motion candidate list based on the reference samples.

84. A non-transitory computer-readable storage medium storing instructions that cause a processor to:
determine, during a conversion between a current block of a video and a bitstream of the video, reference samples of a template or a sub-template of the current block using a Local illumination compensation (LIC) method, wherein a first set of LIC parameters of the template of the sub-templates are determined based on a second set of LIC parameters of the current block; and
determine a target motion candidate list based on the reference samples.

85. A non-transitory computer-readable recording medium storing a bitstream of a video which is generated by a method performed by a video processing apparatus, wherein the method comprises:
determining, during a conversion between a current block of a video and a bitstream of the video, reference samples of a template or a sub-template of the current block using a Local illumination compensation (LIC) method, wherein a first set of LIC parameters of the template of the sub-templates are determined based on a second set of LIC parameters of the current block;
determining a target motion candidate list based on the reference samples; and
generating the bitstream based on the target motion candidate list.

86. A method for storing bitstream of a video, comprising:
determining, during a conversion between a current block of a video and a bitstream of the video, reference samples of a template or a sub-template of the current block using a Local illumination compensation (LIC) method, wherein a first set of LIC parameters of the template of the sub-templates are determined based on a second set of LIC parameters of the current block;
determining a target motion candidate list based on the reference samples;
generating the bitstream based on the target motion candidate list; and
storing the bitstream in a non-transitory computer-readable recording medium.

87. An apparatus for processing video data comprising a processor and a non-transitory memory with instructions thereon, wherein the instructions upon execution by the processor, cause the processor to:
determine, during a conversion between a current block of a video and a bitstream of the video, reference samples of a template or sub-template of the current block according to an Overlapped Block Motion Compensation (OBMC) method; and
determine a target motion candidate list based on the reference samples of the template or sub-template.

88. A non-transitory computer-readable storage medium storing instructions that cause a processor to:
determine, during a conversion between a current block of a video and a bitstream of the video, reference samples of a template or sub-template of the current block according to an Overlapped Block Motion Compensation (OBMC) method; and
determine a target motion candidate list based on the reference samples of the template or sub-template.

89. A non-transitory computer-readable recording medium storing a bitstream of a video which is generated by a method performed by a video processing apparatus, wherein the method comprises:
determining, during a conversion between a current block of a video and a bitstream of the video, reference samples of a template or sub-template of the current block according to an Overlapped Block Motion Compensation (OBMC) method; and
determining a target motion candidate list based on the reference samples of the template or sub-template; and
generating the bitstream based on the target motion candidate list.

90. A method for storing bitstream of a video, comprising:
determining, during a conversion between a current block of a video and a bitstream of the video, reference samples of a template or sub-template of the current block according to an Overlapped Block Motion Compensation (OBMC) method; and
determining a target motion candidate list based on the reference samples of the template or sub-template;
generating the bitstream based on the target motion candidate list; and
storing the bitstream in a non-transitory computer-readable recording medium.
